(19) United States
(12) Patent Application Publication
(10) Pub. No.: US 2006/0150691 A1
(43) Pub. Date: Jul. 13, 2006

(54) Bicycle locks that connect together for convenient storage

(76) Inventor: David Adam Truss, Coquitlam (CA)

Correspondence Address: David Truss, 847 Poirier Street, Coquitlam, BC, V3J 6C2, CA

(21) Appl. No.: 11/326,517

(22) Filed: Jan. 6, 2006

Related U.S. Application Data
(60) Provisional application No. 60/642,972, filed on Jan. 12, 2005.

(51) Int. Cl. E05B 67/22

(52) U.S. Cl. 70/39

(57) ABSTRACT

An improved bicycle lock that gives the user the security of a second bicycle lock for locking components, such as the front wheel, and the advantage of storing the second lock conveniently next to, or within, the confines of the first lock. The plurality of locks are conveniently connected and stored together, when the locks are not in use; each lock works independently when not connected and stored together. Components specific to securing a plurality of connected locks on a bicycle includes, but is not limited to the use of: Tabs (25), Sleeves (24), Grooved Ends (36), Ridged Rings (40), Sleeve Bars (43), and Double Lock Holders (48).

### CROSS-REFERENCE TO RELATED APPLICATIONS

This application claims the benefit of provisional patent application Ser. No. 60/642,972, filed 2005 Jan. 12 by the present inventor. This application also claims the benefit of Disclosure Document No. 572333, filed 2005 Mar. 9 by the present inventor.

### FEDERALLY SPONSORED RESEARCH

Not Applicable

### SEQUENCE LISTING OR PROGRAM

Not Applicable

### BACKGROUND OF THE INVENTION

1. Field of Invention

The present invention lies in the domain of bicycle security and utility locks, and generally relates to a locking device for a bicycle and more particularly to a locking device which is adapted to contain a plurality of U-shaped locks, or alternate shaped locks, along with an effective mounting means and several other supplementing elements.

2. Prior Art

There has been a large amount of activity in the general field of bicycles and utility locks placed on them, specifically for securing a bicycle when it is not in use. The prior art discloses numerous types of utility locks and/or locking devices. At present the commonly known bicycle security locks or locking devices primarily fall in the category of U-shaped locks, cable, and chain and pad lock devices. Besides these, there are also several known locking devices which use various other encircling components as means for securing a bicycle and aimed at theft prevention, such as cuff locks, as well as hinged locks that are circular, oval, and square relatives to the U-lock.

Despite the activity in the fields of utility locks and bicycle security, no prior art was found directly relating to the connecting of two rigid locks when stored and/or not in use. In fact, although there are some limited combinations of U-locks and chain or cable locks available for purchase, there has not been any patent activity in this particular field, relating to the connecting of two or more locks. As a result of this lack of activity many of the prior art locks described below are noteworthy, but not sufficiently adequate for comparison.

U-Locks—One of the more secure and popular bicycle lock designs that is currently available commercially is a U-shaped lock comprised of a U-shaped shackle with a cross bar that houses the locking mechanism. Some bicycle locks, based on this design, are secure and effective enough that the manufacturing company provides financial protection against theft. Some U-Shaped Locks made available under the trademark KRYPTONITE® provide such financial protection, (as recently as January 2005, Kryptonite®'s ‘KryptoLok’, provided $1250 (USD) Anti-Theft Protection available in the USA and Canada). Although these U-Shaped Lock designs, primarily based on U.S. Pat. No. 3,924,426, (Zane, et al., December 1975); U.S. Pat. No. 3,967,475, (Zane, July 1976); and U.S. Pat. No. 4,155,231, (Zane, et al., May 1979), are effective deterrents to theft, these locks are limited by their dimensions. U-Shaped Locks are limited in their size due to the need of keeping them difficult to break, as well as both convenient, and portable.

Another inconvenience arises with U-locks, and other similar locks, when the fixed, stationary post or other secure object that the bicycle is being secured to is thick enough that the front wheel, (or other item that is desirable to secure), does not fit into the lock along with the frame of the bicycle and the rear wheel. Even when there is room to secure the frame and both wheels, it would be necessary to remove the front wheel so that it can be locked alongside of the frame, back wheel, and stationary component/rack that the bicycle is being secured to. Furthermore, these locks can only secure a bicycle at one fixed point, whereas adding a second lock can double this, increase the protection provided, and deter the likeliness of theft.

In order to improve security and reduce the need to remove the front wheel to lock it, manufacturers both recommend, and provide for retail purchase, a combination of both U-Shaped Locks and chain or cable locks sold together. This combination provides users with the opportunity to lock components and accessories that do not fit conveniently within a single U-Shaped Lock. Examples of this can be seen with On Guard® Locks' Bulldog DT5012 or PitbullDT5005, both are sold as combinations of a U-shaped lock and a cable lock. However, storage of the cable lock may be inconvenient, cumbersome, or time consuming (to ravel/unravel and secure to the U-lock), and the security of a cable or chain lock is often easier for thieves to compromise compared to a U-Shaped Lock. Some chain locks such as On Guard®'s Mastiff™ Series may be more difficult to compromise compared to U-Shaped and similar shaped locks, but these chains tend to be significantly bulkier, heavier and less convenient. Often these secondary locks, such as chain and cable locks, used in addition to a U-shaped lock, are stored in panniers or backpacks making them more cumbersome/difficult to carry, or these locks are secured at one location, making them effective only when returning to this location.

Alternate Shaped Locks—Although not specifically a U-Shaped Lock, the Bike Guard®'s ‘Lock Jaw’ designed oval-shaped locks are noteworthy alternatives. Bike Guard®'s Jaw Ultra, as well as the Lock Jaw 2000, and the Lock Jaw 1200, are hinged locks that serve the same function of U-shaped locks. Also serving similar functions to the U-lock, but with a single hinged component rather than two individual components are ring-styled Bike Guard® Bonelocks which are hinged and round, and the Ultra Bike Club™ by The Club®, which is shaped like a rectangle with rounded edges. Each of these hinged locks share the same shortcomings of the previously described U-locks, being limited in space, requiring the removal of the front wheel to be secured with other components, and suggesting the need for a second lock.

Some locks have different, more novel shapes. The Piano Shaped lock, U.S. Design Pat. No. D392,540, (McDaid, March 1999) is unique in design but would be awkward to use, with little if any functional benefit being gained from the different shape. Cuff style locks such as US Pat No. 20020108406, (Makos, et al., August 2002) can lock a bicycle component such that minimal space is left unused within the lock, but these locks are limited in how much they can fit it them. Due to a lack of size, these locks, such as Cuff Locks sold by Master Lock®, have limited capability to add components, such as a removed front wheel, into the secured space of the lock. Therefore, these locks would serve more conveniently as a secondary supporting lock rather than a primary bicycle lock.

Locking Mechanisms and Shackle Feet—Conventional locks and locking mechanisms are necessary components of utility locks. The location of the lock and locking mechanism can vary on prior art U-locks. U.S. Pat. No. 5,406,812, (Jaw, April 1995) places the locking mechanism on one end of the locks' crossbar. This lock has two straight feet for the U-shaped shackle that are secured within the aligned openings of the cross bar, a common design with U-locks. U.S. Pat. No. 5,257,517, (Dale, November 1993) also has the locking mechanism on one end of the locks' crossbar, but with a large reinforcing shield that begins at the locking case and continues along the cross bar to encase the nearest aligned opening on the lock's cross bar. U.S. Pat. No. 5,092,142, (Zane et al., March 1992), which has one straight foot and one bent foot on the U-shaped shackle, places the locking mechanism on the opposite side of the aligned openings on the cross bar, (between the aligned openings and closer to one opening than the other). The locking mechanism is placed closer to the aligned opening that receives the straight foot to secure this end of the shackle, while the second foot is secured by the bend after it is received in the other aligned opening. Yet another lock, U.S. Pat. No. 5,787,736, (Ling, August 1998) places the locking mechanism in the center of the cross bar, on the opposite side of the aligned openings, and has the added feature of a combination lock instead of a key entry. Each of the locks described above, despite their unique attributes, share the same limiting challenge of size and efficiency, that U-locks do, limiting their ability to secure all necessary components on a bicycle.

Self Locking and Push Locks—Some locks are easier to close or secure than others. Self-locking U-Locks such as the ABUS® Manhattan Lock would be functionally easy to close, just as a push lock such as the ABUS® Granit Plus 51 Lock would be. Push locks, some of which are based on U.S. Pat. No. 5,133,203, (Huang, July 1992) and U.S. Pat. No. 5,195,340, (Huang, March 1993), like self-locking locks, are easy to lock. Because push locks only need to have the inner ‘push rod’ pushed in to lock them, there is no need to worry about using the key to lock the locks, thus, like self-locking locks (see Hsieh below), you are free to use your hands to concentrate on fitting or resting the locks together as required. Like push locks, U.S. Pat. No. 5,488,845, (Hsieh, March 1994) which locks automatically aided by coil springs that engage when the key is turned to the unlock position, would also prove to be easy to use. However, the efficiency of push and self locking locks does not compensate for the shortcomings of the U-locks the are place on, (as already explained).

Lock Holders—Two prior art bicycle lock holders, U.S. Pat. No. 4,736,921, (Zane, et al., April 1988), or the EZ Mount Bracket, by Kryptonite®, based on U.S. Pat. No. 6,422,442, (McDaid, et al., July 2002), are effective at holding a lock to a bicycle frame. However these lock holders, and other lock holders patented or available for purchase, are only capable of securing one lock to the frame of the bicycle and require a second lock holder if a second lock is wanted or needed. A second lock holder on a bicycle, using any of the current lock holders on the market, requires significantly more space to be used on a bicycle for securing the second lock, than storing just one lock.

3. Objects and Advantages

This invention relates generally to bicycle and utility locks, and pertains, more specifically, to an improvement on existing locks whereby locks are connected and stored together when not in use. Although described primarily as U-shape locks, the locks used in this invention may take on many different, alternate shapes. In fact all rigid locks, used for securing (primarily) bicycles, found in prior art searches could be used as one or more of the connected locks as described in this invention.

Advantages Over Prior Art—All of the prior art locks described above can be used in conjunction with this invention, whereby this invention can be used to connect two or more already invented prior art locks, or a prior art lock to a newly designed lock. More than one prior art lock can be securely connected together within the confines of a space not bigger than, or not significantly bigger than, storing one lock, until the locks are needed at which time these locks are fully separable.

In view of the foregoing disadvantages inherent in the above mentioned prior art, the general purpose of the present invention is to provide an improved combination of convenience and utility, to include all the advantages of the existing prior art, and to overcome the above mentioned disadvantages/drawbacks of the prior art.

The present invention relates to a new lock securing device in which there exists a plurality of locks aimed at enhanced bicycle security. Storage of one lock connected within the confines of, or placed adjacent to, a second lock is accomplished at a single place when the lock(s) are not being used to secure the item(s) they were purchased to secure. The convenience of storing two or more successive locks in this fashion is useful when the locks are stored on a bicycle, moped, scooter, motor cycle or other valuable possession where the security of locking such items is necessary, the convenience of a second lock or successive lock(s) is desirable, and storage space may be limited. A second lock stored in one of the ways suggested in this invention creates an advantage over prior art locks in that this invention gains the benefit of a second lock to secure more items such as a front wheel, (without having to remove it from the bicycle), as well as securing the bicycle to a stationary item(s) a second time; while requiring little if any additional space for storage on a bicycle.

When the locks of the present invention are separated, they work independently of each other and can be used to greatly increase the security, the convenience and the volume or number of items being secured.

Key Advantages—Bicycle commuters would find this invention most advantageous. Although these advantages benefit all bicycle users with their bicycle security, commuters have some common challenges that, when combined, make them ideal candidates to take full advantage of this invention. Bicycle commuters would benefit greatly since they:

a) Leave their bicycles unattended in public places, often with great risk of theft, so a second lock would act as a significant theft deterrent.

b) Take the time to remove their quick-release front wheel from their bicycle in order to secure it within the confines of their lock, along with using this same lock to secure their rear wheel, and bicycle frame, to a bicycle rack or another immobile stationary object. A second lock saves time and energy by reducing the need to remove the front wheel from the bicycle to secure it. Furthermore, commuters that have a front wheel that is bolted on rather than quick-release still tend to secure this wheel with a second lock.

c) Are more concerned with scurity since they depend on their bicycle as a key means of transportation. For this reason commuters are more likely to want to carry a second lock with them, and will often end up carrying a second lock in a backpack or pannier, using up storage space unnecessarily.

d) Would find it easier to carry and use two rigid locks, rather than carrying a cable or chain lock as a secondary means of securing their bicycle. Many commuters choose a chain or cable lock for their second lock since space on a bicycle is at a premium.

e) Use much of the existing space on the bicycle to place a water bottle, bicycle pump, panniers etc. thus reducing the availability of space on a bicycle to place a second lock. So, adding a second lock within the confines of, or adjacent to, the first lock provides them with added security without requiring more space on the bicycle.

f) Are more likely to have other items that they may wish to secure on a bicycle. Commuters would use the added space of a second lock to store other items with their bike such as a helmet, a second traveler's bicycle (such as a child's), a backpack or pannier, or a quick-release seat.

g) Are more likely to use their lock properly, and are aware of the value of having a second lock, stored effectively and efficiently on their bicycle. Many bicycle users use a lock improperly locking only their frame, and exposing wheels and other components to theft. Commuters are savvy about protecting their bicycle and would recognize the value of using this invention to protect their personal property.

Other advantages are noted in the ‘Conclusion, Ramifications and Scope’ section. Eight challenges are recognized in addition to the advantages of this invention that alleviate these challenges.

Key Objects—The principle object of the present invention is to provide a locking device wherein, the enhanced and better security is achieved by a plurality of locks, which when put to use immobilizes the secured bicycle and/or bicycle components at several places.

Another objective of the present invention is to provide a locking device, wherein the plurality of locks can be stored adjacent to, or within the confines of, a single lock, thus optimizing on the aspect of storage at single place, when the locks are not put to use.

Yet another objective of the present invention is to provide a locking device, which remains attached to the bicycle at all times. The present invention has been conceptualized with a further objective of providing more than one locking device, which can be regarded as an integral part of the bicycle. This is advantageous compared to storing a second lock in a pannier, backpack, gym bag, or otherwise away from the bicycle.

Yet another objective of the present invention is to provide a locking device which can be regarded as an integral part of a bicycle's inherent security.

These together with other objects of the invention along with the various features of novelty that characterize the invention are pointed out with particularity, in the claims annexed hereto and forming a part of this disclosure. For a better understanding of the invention, its operating advantages and the specific objects attained by its user, reference should be made to the accompanying drawings and descriptive matter in which these are illustrated exemplary embodiments of the invention.

### SUMMARY

This invention pertains primarily to a U-Shaped Lock, but also ring-styled locks, oval-shaped, and square-shaped locks, and other locks, including handcuff locks and anchor locks, used to secure bicycles and other recreational vehicles. One or more rigid locks, or a lock holder, or an independent sleeve, are modified so that at least one more lock is secured conveniently to it, or next to it. The advantage of storing more than one lock this way is particularly convenient on a bicycle where storage space is limited.

To achieve the advantage of having more than one lock connected together in a limited space, while stored on a bicycle, the locks may be:

A) Connected with one lock stored within the confines of a second lock, when these locks are not being used to secure the item(s) they were purchased to secure;

B) Stored connected by means of an additional component and/or lock holder;

C) Stored side-by-side, either attached to each other, and/or mutually attached to an additional component, or lock holder.

The convenience of storing two locks in one of these fashions is useful when such locks are stored on a bicycle, moped, motor scooter, motorcycle or other valuable possession, where the security of locking such items is necessary, the convenience of a second lock is desirable, and storage space may be limited. When separated both locks work independently of each other and can be used to greatly increase the security, the convenience and the volume or number of items being secured.

### DRAWINGS—FIGURES

In the drawings, closely related figures have the same number but different alphabetic suffixes.

FIG. 1 shows two locks secured together with a Sleeve, when they are not being used.

FIGS. 2A and 2B show a perspective view of a Sleeve embodiment with locks separated and independently locked.

FIGS. 3A and 3B show two views of a Tab embodiment with locks secured together.

FIGS. 4A to 4C show Tab embodiments with locks separated and together.

FIGS. 5A to 5E show combination Tab and Sleeve embodiments, with different sizes and locations for Tabs and Sleeves.

FIGS. 6A to 6G show combinations of alternate shaped locks, other than U-locks, either combined with U-locks or combined with other alternate shaped locks.

FIGS. 7A and 7B respectively show combinations of locks, first with U-shaped shackles having two straight feet, and then with U-shaped shackles having one straight foot and one bent foot.

FIGS. 8A to 8C show three views of a lock having two U-shaped shackles that share a common cross bar.

FIGS. 9A to 9D show embodiments and components of an Inner lock with grooved cross bar ends that can be fitted to an Outer lock.

FIG. 10 shows a Tab variation inner and outer lock securing a bicycle to a signpost, and securing the front wheel of the bicycle to the bicycle's frame.

FIGS. 11A to 11B show different ways that lock holders can secure the invention to a bicycle.

FIGS. 12A to 12D show fragmentary perspectives of inner cross bars with a sleeve, and outer cross bars that fit securely together with the inner cross bar by means of the sleeve.

FIGS. 12E and 12F show two alternate shapes for outer cross bars and for sleeves on inner cross bars.

FIGS. 13A to 13C show embodiments with vertical sleeves: the first two vertical sleeves shown penetrate the inner cross bar, while the third embodiment, FIG. 13C, shows a vertical sleeve added to the ends of the inner cross bar.

FIG. 14 shows two locks that can be secured together with Ridged Rings.

FIGS. 15A and 15B show that more than two locks can be secured together.

FIGS. 16A to 16C show embodiments of a cross bar that is penetrated by a sleeve to receive bent shackle legs from a second lock.

FIG. 17A shows a Sleeve embodiment that secures two locks side-by-side.

FIGS. 17B to 17E show embodiments of Sleeve Bars that act as independent components used to secure two locks together when the locks are not in use.

FIGS. 18A to 18D show embodiments of Tab Extension Arms used to bridge a gap between the Tab on an inner shackle with the arc of the outer shackle, when an inner lock is secured within the confines of an outer lock.

FIGS. 19A and 19B show prior art lock holders.

FIGS. 19C to 19I are embodiments of bicycle Lock Holders used to connect more than one lock to a bicycle.

FIG. 19J shows multiple possible relationships between a lock holder's bracket used to secure a lock to a bicycle, and two brackets used to secure locks.

FIGS. 20A to 20C show how Clips, Cords, and Straps can be used to help secure two locks together when they are not being used.

### DRAWINGS—REFERENCE NUMERALS

21 Inner U-Shaped Lock
22 Inner U-Shaped Shackle
23 Inner Cross Bar
24 Sleeve
25 Tab
26 Outer U-Shaped Lock
27 Outer U-Shaped Shackle
28 Outer Cross Bar
29 Lock Case and Locking Mechanism 43 Sleeve Bar
30 Bicycle Frame
31 Lock Holder
32 Inner Cross Bar Aligned Openings
33 Outer Cross Bar Aligned Openings
34 Tongue of a Tongue and Groove
35 Groove of a Tongue and Groove
36 Grooved Ends
37 Key for Lock Case and Locking Mechanism (29)
38 Straight Foot of U-Shaped Shackle's legs
39 Bent Foot of U-Shaped Shackle's legs
40 Ridged Rings
41 Vertical Sleeve
42 High Compression Foam
44 Tab Extension Arm
45 Lock Holder Clip
46 Lock Holder Clip Release Button
47 Lock Holder Pressure Lever
48 Double Lock Holder
49 Clip
50 Cord
51 Strap
52 Hinge

### DRAWINGS—DETAILED DESCRIPTION OF REFERENCE NUMERALS

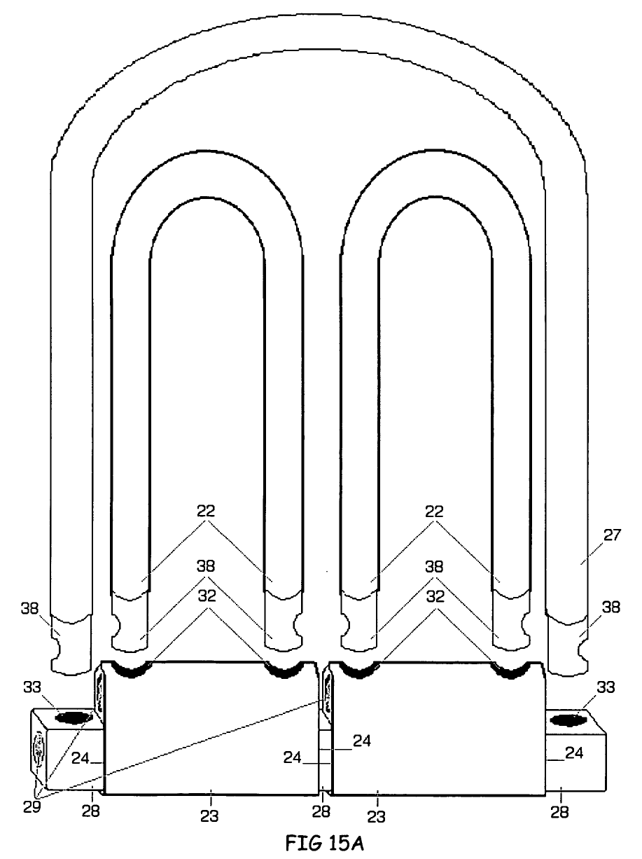

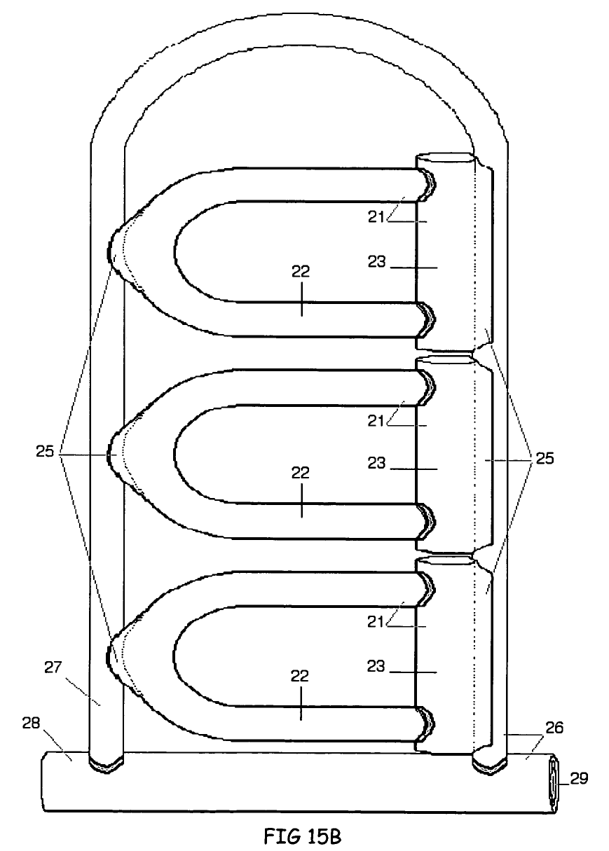

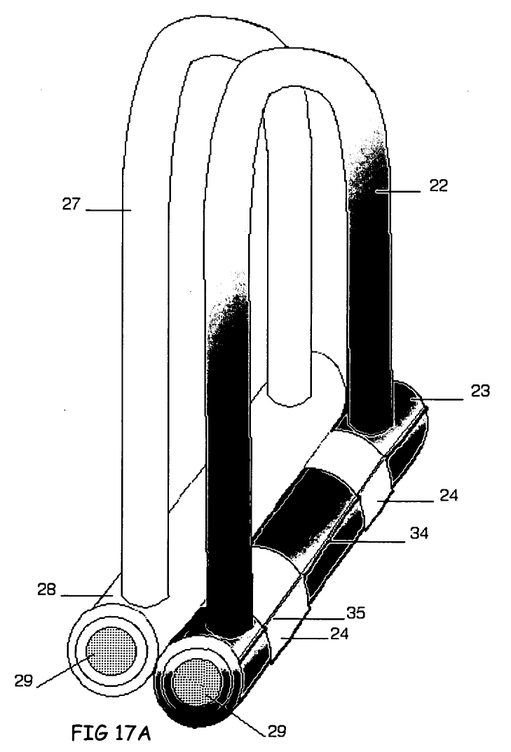

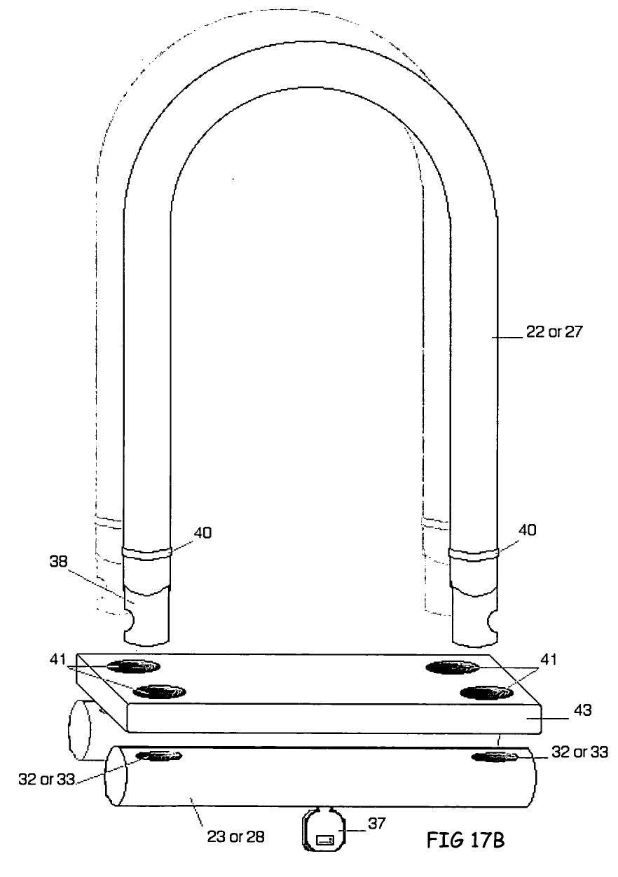

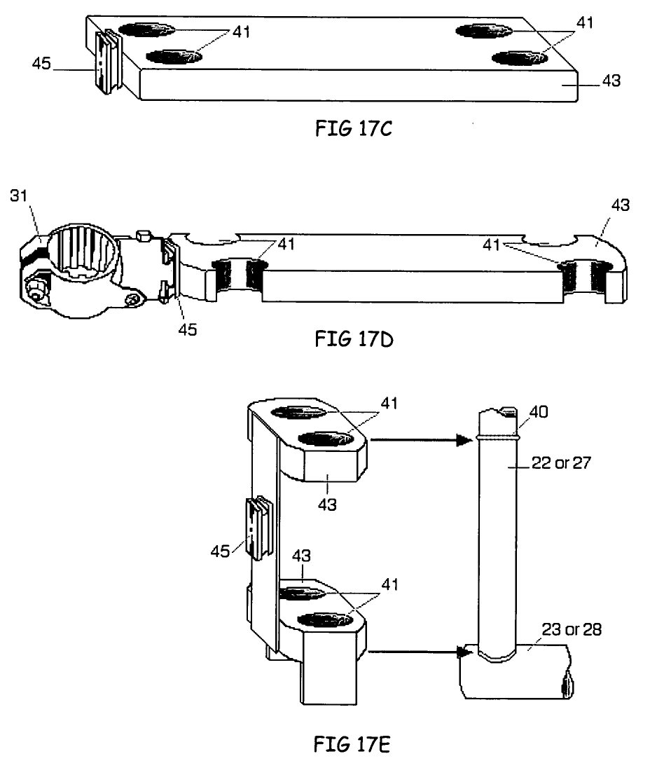

21 Inner U-Shaped Lock—This component is comprised of two main parts that fit together; the Inner Cross Bar 23 and the Inner U-Shaped Shackle 22. This lock is named the Inner Lock since it is the lock that is usually, (though not necessarily), connected inside a second lock, the Outer U-Shaped Lock 26, when the two locks are fastened together. Other components may or may not be present as required by the specific variation of this invention being described. These added components include, but are not limited to, Sleeves 24, Tabs 25, Tongues 34, Grooves 36 and Rings 40 which would be features added to the Cross Bar 23 and/or U-Shaped Shackle 22 as needed in order to meet the need of connecting the two locks together securely, and conveniently, when the locks are not in use. Note that there may be more than one Inner Lock present in some variations of this invention, (see FIGS. 15A and 15B). See also Outer U-Shaped Lock 26 (below). When considering locks that are connected side-by-side, either of the locks could be considered an Inner Lock 21 or an Outer Lock 26, unless their positioning suggests that one lock be considered specifically one or the other, (as seen in FIG. 17A).

22 Inner U-Shaped Shackle—The Inner U-Shaped Shackle 22 is fastened together with the Inner U-Shaped Lock's Cross Bar 23 by means of ‘feet’ (see 38 and 39) that fit into, and are secured within, the Inner Aligned Openings 32 on the Cross Bar 23 of the Inner U-Shaped Lock 21.

The U-Shaped Shackle component is what gives the “U-Shaped Lock” its' name. It is one of two major components that the Inner and Outer U-Shaped Locks 21 and 26 are comprised of. There are a lot of conventional designs that suggest different sizes, and shapes for this part of the lock. Most conventional designs suggest that it is a rigid bar that has two parallel legs of equal length that are connected by a U-shaped curve in the bar. This invention will work with these conventional designs and other designs that are less conventional. Where this invention varies from other designs is with regards to the components that are added to either the U-Shaped Shackle(s) 22 and 26, and/or the U-Shaped Lock's Cross Bar(s) 23 and 28, and/or additional components (described in detail herein), in order to meet the need of connecting the two, or more, locks together securely, and conveniently, when the locks are not in use. See also, Outer U-Shaped Shackle 27, on an Outer U-Shaped Lock 26 (both described below).

23 Inner Cross Bar—This component and the Inner U-Shaped Shackle 22 make up the two essential components of the Inner U-Shaped Lock 21. The Inner Cross Bar 23 holds the two Aligned Openings 32 and the Lock Case and Locking Mechanism 29 needed to secure the Inner U-Shaped Lock's U-Shaped Shackle 22 to it.

24 Sleeve—Sleeves are hollow openings used primarily to secure a component of one lock to a component of another lock. Sleeves can also be described as either tubes or rings, (note Ridged Rings 40). Sleeves, as used in this invention, are durable and well joined extensions placed on a lock, independent Sleeve Bar 43, or Lock Holder 31, that are used to enclose or encase a component of another lock in order to connect the locks together when they are not in use. Sleeves allow the second lock to slide into them when the two locks are secured together, and out of them when the locks are separated for independent use. Sleeves would be designed to fit snugly over the component of the held lock such that the two segments are completely limited in their ability to move independently of one another. They are placed in a position on one or both of the locks, sometimes along with other components including Tabs 25, Ridged Rings 40, Tongues 34 and Grooves 35, so that when the two locks are secured together, they are securely held in place, and so that the two locks can not move independently of one another. In order to secure these two locks together, there may be a combination of one or more Sleeves, and/or Tabs 25, and/or other components mentioned, placed on:

One or both of the U-Shaped Lock's U-Shaped Shackle (22 and 27); and/or

The U-Shaped Lock's U-Shaped Cross Bar (23 and 28); and/or

An independent component, such as Sleeve Bar 43 (as seen in FIG. 17B).

Also, some variations of this invention include the use of sleeves to secure more than two independent locks together using the same principles of snugly confining the locks together so that, when stored together, they cannot move independently of one another. In some locations where sleeves are used, it may be possible to us a Tab 25 or Clip 49 instead.

25 Tab—Tabs are small flaps, strips, or tongues that extend as an additional appendage on one or more of the components of a lock or lock holder. Tabs are durable, well joined extensions place on a lock, or lock holder, that are used to embrace, firmly butt against or intertwine with part of another lock, when two locks are secured together. Tabs can be used in conjunction with other Tabs, Sleeves 24 or other components such as Ridged Rings 40, Tongues 34 and Grooves 35, in order to ensure that when the two locks are fastened together they may not move independently of one another. Tabs and Sleeves 24 are very similar in purpose, but fundamentally different in that Sleeves completely surround, or encircle, components of a lock whereas Tabs partially embrace the component(s) of a lock without enclosing completely around them.

The terms grooves, ridges and tongues are all described as part of the tab family, since they too can be defined as small flaps, strips, or tongues that extend as an additional appendage. Although a specific variation of a ridge, the Ridged Ring 40 and two variations of a groove, the Grooved Ends 36 and the Tongue and Groove (34 and 35) are identified separately from tabs, the traits or end purposes of these variations place them in the category or family of Tabs 25.

26 Outer U-Shaped Lock—This component is comprised of two main parts that fit together: the Outer Cross Bar 28, and the Outer U-Shaped Shackle 27. This lock is named the Outer Lock since it is the lock that usually, but not necessarily, fits over top of, or outside of, a second lock, the Inner U-Shaped Lock 21, that may be connected inside it when the two locks are fastened or connected together. Other components used to connect the locks may or may not be present as required by the specific variation of this invention being described. These added components include, but are not limited to, Sleeves 24, Tabs 25, Tongues 34, Grooves 36 and Rings 40 which would be features added to the Cross Bar 28 and/or U-Shaped Shackle 27 as needed in order to meet the need of connecting the two locks together, conveniently, when the locks are not in use. Note that many of the design variations of this invention would require that the Inner Lock, (or locks), be locked in their closed position before the Outer Lock can be placed over top of, or around them. Also, in many of the variations of this invention, one of either the Inner or Outer U-Shaped Locks (21 and 26) locks may be of a conventional design, using a lock currently sold in stores, while the other lock, or additional components or lock holders have all the necessary added components to implement the usefulness of this invention. See also Inner U-Shaped Lock 21, (described above).

27 Outer U-Shaped Shackle—See also, Inner U-Shaped Shackle 22, (above).

This component is what gives the “U-Shaped Lock” its' name. It is one of two major components that the Outer U-Shaped Lock 26 is comprised of.

This U-Shaped Shackle is fastened together with the Outer Cross Bar 28 by means of ‘feet’ (see 38 and 39) that fit into, and are secured within, the Outer Aligned Openings 33 on the Cross Bar 28 of the Outer U-Shaped Lock 26.

An example of an alternate shape for a U-Shaped Shackle 22, or 27, is the Piano Shaped lock, U.S. Design Pat. No. D392,540, (McDaid, March 1999).

28 Outer Cross Bar—This component contains both the Outer Aligned Openings 33 and the Lock Case and Locking Mechanism 29 needed to secure the Outer U-Shaped Lock's U-Shaped Shackle 27 to it. Where this invention varies from conventional designs is with regards to the components that can be added to the Cross Bar component, the Outer U-Shaped Shackle 27, or to other components (described in detail herein), in order to meet the need of connecting the two locks together, conveniently, when the locks are not in use. The purpose of these added components would be to connect the other lock(s) to this lock when the two, or more, locks are secured together.

29 Lock Case and Locking Mechanism—These components are all based on conventional designs. They are usually place on the Cross Bars (23 and 28) of a U-shaped lock. Their position and design vary depending on the lock design. This invention will work successfully with any locking Mechanism currently placed on bicycle locks. With some variations the location of these components would be more desirable than others. Although not shown in the figures, this invention will also work with a variety of combination, keyless locks currently available on U-locks, as well as with disc-style cylinder locks currently being placed on newer locks.

30 Bicycle Frame—The body or structure of fitted components, of a bicycle. Bicycle frames can vary significantly in overall design.

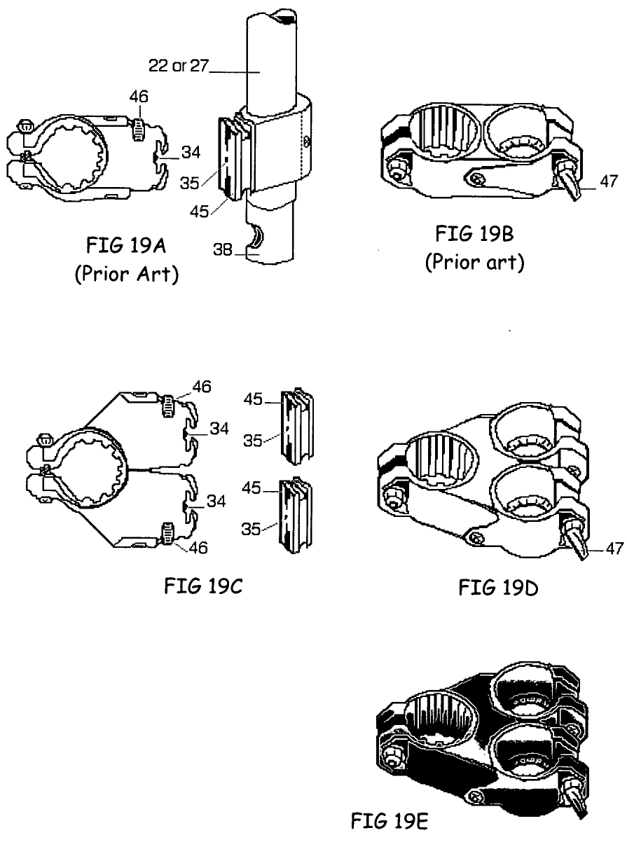

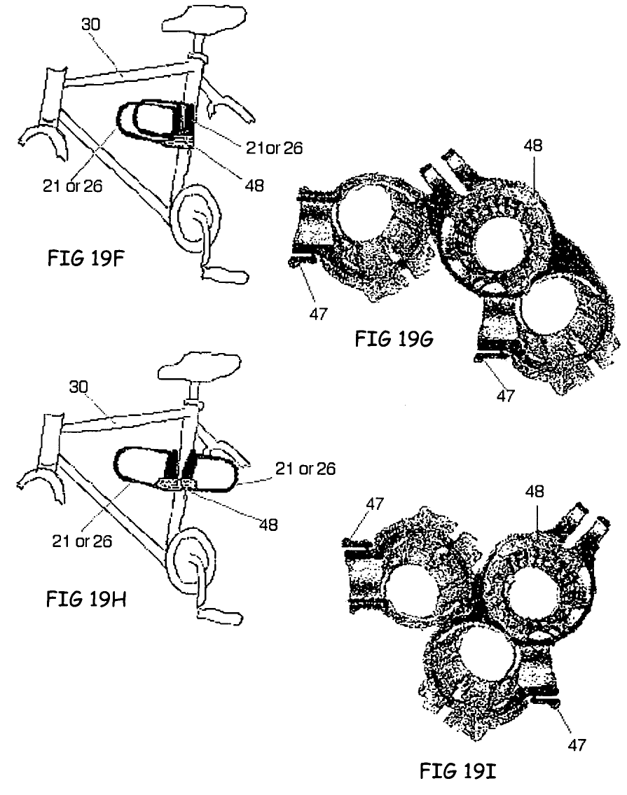

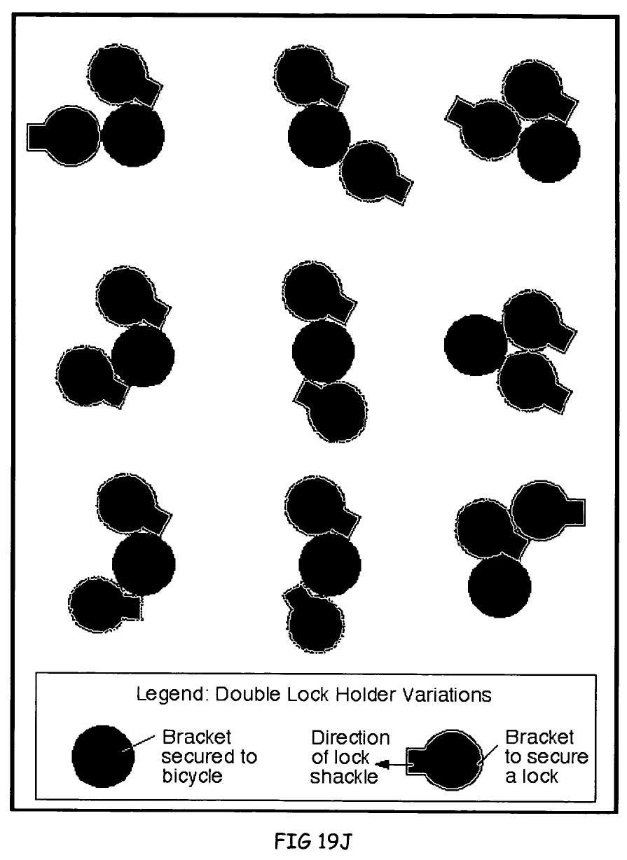

31 Lock Holder—Many current Lock Holders used to secure a bicycle lock to the frame of a bicycle can be used with this invention. Some would require minor design adjustments to accommodate the second lock, and still others such as U.S. Pat. No. 5,647,520, (C. McDaid, August 1997), could be adapted specifically for this invention as mentioned in the ‘Detailed Description—Alternate Embodiments’ section. Furthermore, Double Lock Holders 48 are a specific kind of Lock Holder used for the purpose of securing more than one lock on a bicycle. Note the comprehensive description of Lock Holders 31 in the ‘Detailed Description—Preferred Embodiments’. Sections regarding FIGS. 19A and 19B are about lock holders in general and sections regarding FIGS. 19C to 19J are specifically about Double Lock Holders 48.

32 Inner Cross Bar Aligned Openings—The openings that allow the ‘feet’ of the Inner U-Shaped Lock's U-Shaped Shackle 22 to be secured to the Cross Bar 23. Within these openings the locking mechanism secures the ‘feet’ such that the Cross Bar 23 and U-Shaped Shackle 22 are combined as a single locked unit. The locking mechanism within the openings may secure both ‘feet’ as in the case with most locks containing two straight ‘feet’, or one opening may secure a Bent Foot 39 while the other locks and secures a Straight Foot 38.

33 Outer Cross Bar Aligned Openings—The openings that allow the ‘feet’ of the Outer U-Shaped Lock's U-Shaped Shackle 27 to be secured to the Cross Bar 28. Within these openings the locking mechanism secures the ‘feet’ such that the Cross Bar 28 and U-Shaped Shackle 27 are combined as a single locked unit. The locking mechanism within the openings may secure both ‘feet’ as in the case with most locks containing two straight ‘feet’, or one opening may secure a Bent Foot 39 while the other locks and secures a Straight Foot 38.

34 Tongue, of a Tongue and Groove—The male, protruding or projecting component of a joint that has a protruding strip and matching Groove 35 (below). The tongue and groove are used to secure two items in such a way that they can not slip or move in any direction other than on the axis that the two pieces are initially placed together. In the case of this invention the tongue and groove are used on the Sleeve(s) 24, the Cross Bar(s), (23 or 28), the U-Shaped Shackle(s), (22 or 27), and/or on a lock holder (or independent component), with a component on one lock/lock holder having the Tongue 34 and a component on the other lock(s)/lock holder having the Groove 35.

35 Groove, of a Tongue and Groove—The female, hollow or indented component of a joint that has a matching protruding strip that fits into the groove. (See Tongue 34 of a Tongue and Groove, above). Tongue and Groove joints between parts of two different locks, or a lock and a lock holder, may or may not by themselves be a means for the locks to be secured together, they may also be a means to reduce or restrict movement between two locks when they are connected together.

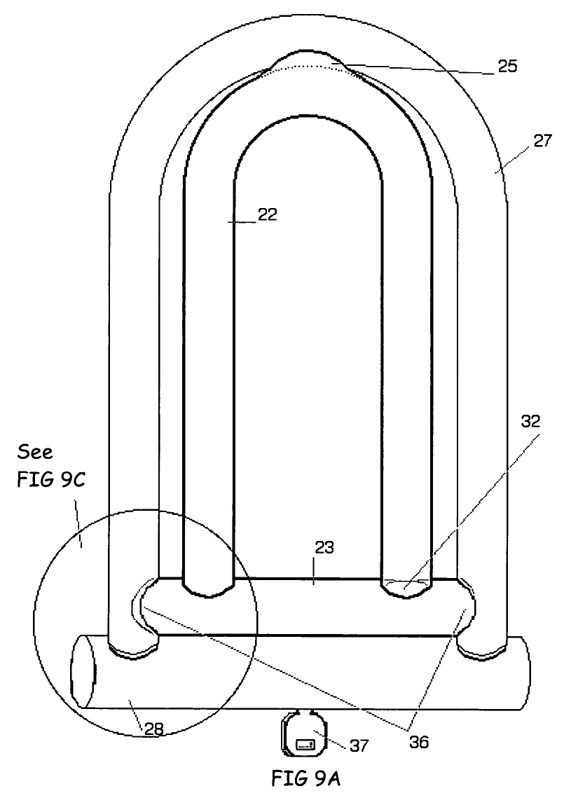

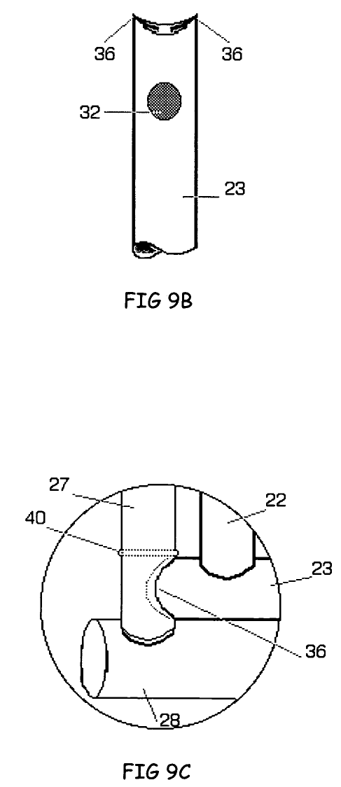

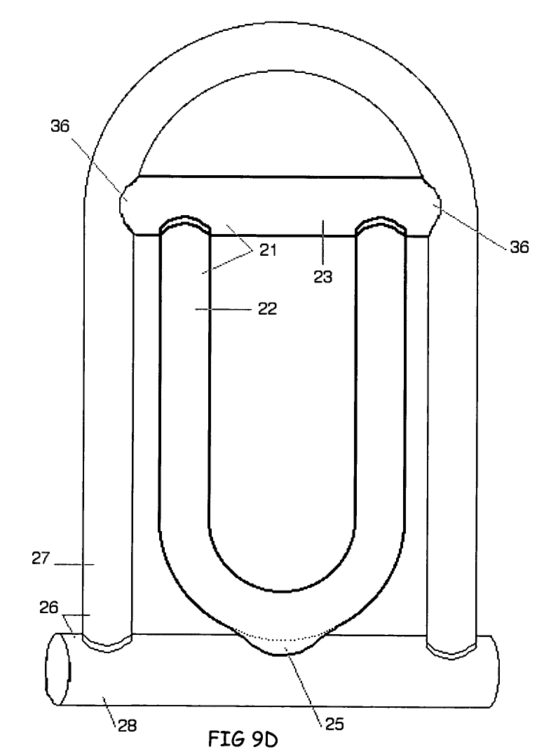

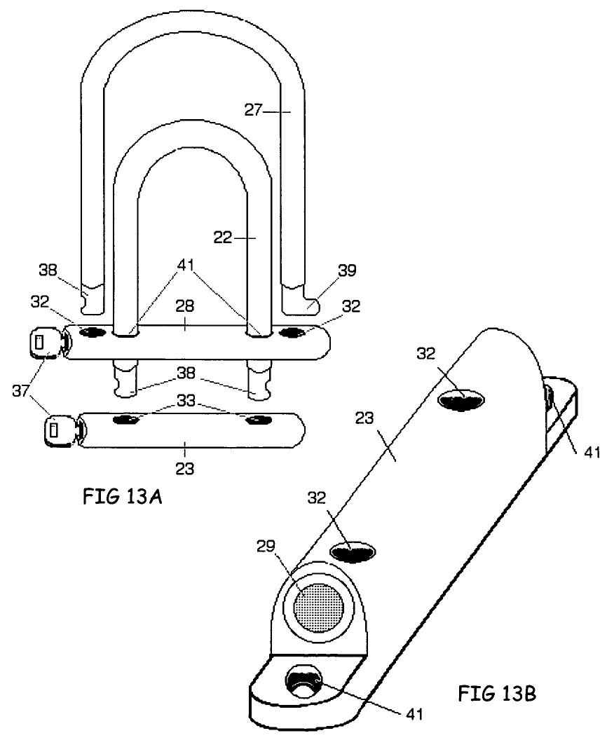

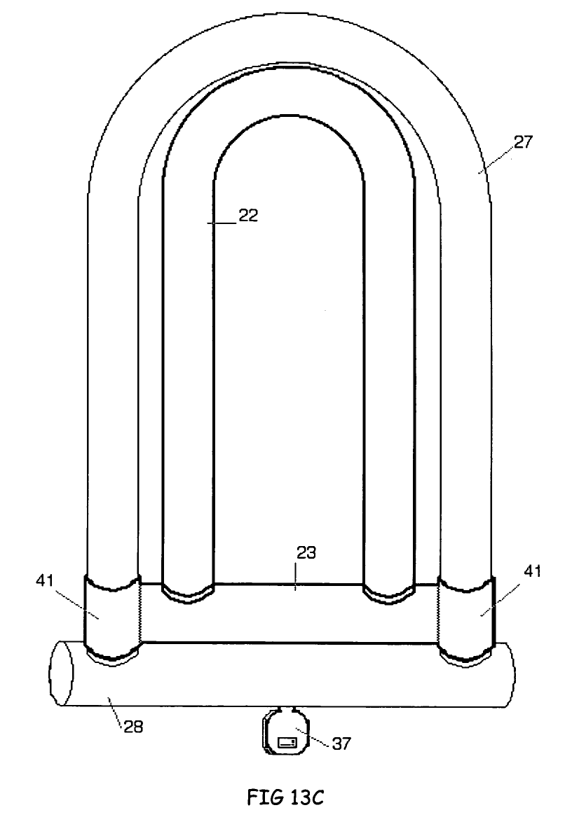

36 Grooved Ends—As seen in FIGS. 9A and 9B, this is a version of a Tab 25 located on the outer ends of the Inner lock's Cross Bar 23. It uses the legs of the Outer lock's U-Shaped Shackle 27 as the tongue sections of a tongue and groove assembly. These Grooved Ends work in a similar way to the Vertical Sleeve 41 shown in FIG. 13C. Grooved Ends could also be located in other locations, such as the inside sections of the Outer lock's U-Shaped Shackle 27 legs in order to secure the ends of the Inner Cross Bar 23.

37 Key—These are conventional keys used to secure the conventional Lock Case and Locking Mechanism 29, which in turn are used to secure the U-Shaped Shackles (22 and 27) to the Cross Bars (23 and 28). Although not shown, combination locks, and possibly in the future electronic locks, can eliminate the need to use keys with the accompanying locking mechanism.

38 Straight Foot, on end of the U-Shaped Shackle's, (22 and 27), legs—A variety of conventional designs, all of which consist of a groove of varying size and/or shape, used by the internal locking mechanism to secure the Cross Bar (23 or 28) to the U-Shaped Shackle (22 or 27).

39 Bent Foot, on end of the U-Shaped Shackle's, (22 and 27), legs—A variety of conventional designs, all of which consist of a bend in one of the legs of the U-Shaped Shackle's, (22 and 27), leg. When this Bent Foot 39, (preferably sloping outwardly at an obtuse angle, as seen in many conventional designs), is positioned in its' Aligned Opening (32 or 33) the opposing Straight Foot 38 can be placed it its' Aligned Opening (32 or 33) and locked, thus preventing the bend in the Bent Foot from being removed from the aligned opening unless the other foot is unlocked.

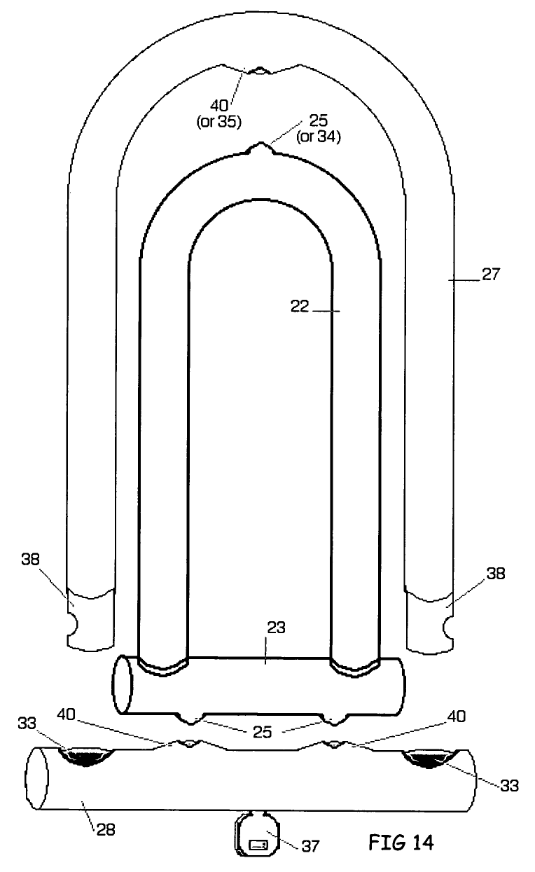

40 Ridged Ring—Ridged Rings serve to prevent movement between the Inner and Outer locks when these two locks are secured together. They would be placed so that a Tab 25, Sleeve 24, Groove 36, or other component described herein, on one lock, (or independent component or lock holder), would be unable to slide or shift due to the positioning of the Ringed Ridge on the other lock, (or independent component or lock holder), when the locks are connected during storage. An entire Ridged Ring may not be necessary, a small ridge, bump or protuberance located directly adjacent to the Tab 25, Sleeve 24, or Groove 36 could restrict the movement of the second lock without necessarily being a ring that completely surrounds the U-Shaped Shackle's, (22 and 27), legs or other section of one of the locks, (or independent component or the lock holder). In the case of FIG. 15A a Ridged Ring 40 could surround the Outer U-Shaped Lock's Cross Bar 23 between the two Inner Locks to make positioning the two locks on to the Outer Cross Bar 23 easier, (this variation is noted, but not shown, in the Figure). Note: In this text the term ring refers to a raised component that bulges out from the object it is attached to, whereas any hollow ring used to hold two separate items together is described as a Sleeve 24. Also, a ridged ring, which is simply a type of ridge, can also be described as a Tab 25 since it can be mutually defined as a small flap, strip, or tongue that extends as an additional appendage. Note also that in FIG. 14 the Ridged Ring can also be described as a raised Groove 35 of a tongue and groove assembly.

41 Vertical Sleeve—Vertical Sleeves are Sleeves 24 that secure the U-Shaped Shackle, (22 and 27), rather than the Cross Bar(s), (23 and 28). As demonstrated in FIGS. 13A, 13B, 13C and 17B, there are a variety of possible positions for a Vertical Sleeve to be placed, including on an independent component, (as shown in FIG. 17B), or on a lock holder.

42 High Compression Foam—The use of such foam may be desirable, but in many cases it would be optional rather than necessary. An example would be a polyurethane or polyimide foam. The purpose of using foam is to act as a friction-reducing element and to provide a cushion between two locks, or locks and a lock holder, that are secured together. This friction-reducing element would be used such that the space between the connected components of the locks are filled and the locks act more like a single unit: thus reducing any independent shifting or rattling etc. between the said independent parts, when they are connected and/or stored together. This may be particularly valuable to compensate for allowable size tolerances between locks intended to be the same size.

43 Sleeve Bar—The idea of having an independent bar to secure, or connect, at least two locks together side-by-side, as shown in FIG. 17B, (or with one lock secured within the confines of a second lock), has some advantages. The primary advantage is that such a bar can be retro-fitted to existing lock designs. A Sleeve Bar, however, need not be independent, and can be added to another lock component, (similar to the Vertical Sleeve 41 shown in FIG. 13B, or a tandem vertical sleeve that is attached to the length of a cross bar), or it can be part of, or attached to, a lock holder as described herein. See the detailed description of Sleeve Bars 43 in the ‘Detailed Description—Preferred Embodiments’ section regarding FIG. 17B.

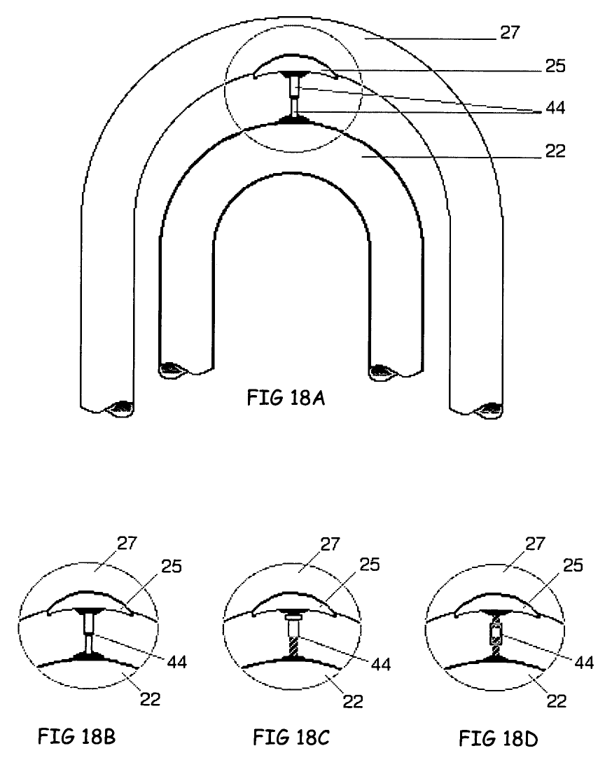

44 Tab Extension Arm—The purpose of the Tab Extension Arm is to maintain a tight fit between the Tab 25, (attached by the extension arm to the Inner U-Shaped Lock's Shackle 22), and the Outer U-Shaped Lock's Shackle 27 when the two locks are secured together. The utility of a Tab Extension Arm lies in the fact that an Inner U-Shaped Lock 21 can be designed to fit one of several conventional Outer U-Shaped Locks 26, (even from competing manufacturers), since it has components that allow the length of the extension arm to vary in size. There are many possible ways to make a Tab Extension Arm serve its' size varying function, three of which are described in the ‘Detailed Description—Preferred Embodiments’ section below, and shown in FIGS. 18B, to 18D. As shown, there are many conventional joints and connectors that would serve well as part of the Tab Extension Arm, allowing the Tab 25 to remain fixed in position on the Outer U-Shaped Lock's Shackle 27 when the arm is compressed/shortened or expanded/lengthened as needed. Furthermore, it is also possible to use this extension arm with the addition of Clips 49, Cords 50, and/or Straps 51, (mentioned below) used in conjunction with, or instead of Tabs 25. An extension arm could also be used in conjunction with a Sleeve 24, rather than a Tab 25. An extension arm can also be an independent component that must be attached or connected to both locks.

45 Lock Holder Clip—A component, independent of the Lock Holder (31 or 48), that is securely attached to a part of a lock. The clip fastens securely into the lock holder when the lock is not in use. For more information, note the description in the ‘Detailed Description—Preferred Embodiments’ section regarding FIG. 19A. The lock holder clip could also be attached to an independent component such as a Sleeve Bar 43 as seen in FIG. 17C.

46 Lock Holder Clip Release Button—This button, on a Lock Holder 31 or Double Lock Holder 48, releases the Lock Holder Clip 45, attached to the lock(s), from the Lock Holders (31 or 48).

47 Lock Holder Pressure Lever—This ‘quick release’ lever is used to squeeze and tighten the excess space around a lock, placed on a Lock Holder 31 or 48. When the lever is flipped up, and away from the body of the lock holder, the tension on the lever is released, widening the space around the lock, thus allowing the lock to be removed from the lock holder.

48 Double Lock Holder—Double Lock Holders 48 are lock holders, specific to this invention, used for the purpose of connecting or securing more than one lock to a bicycle. Double Lock Holders 48 can serve the purpose of connecting and securing locks together when they are not in use, even when these locks do not have components to help the locks connect together. Note the detailed information on lock holders in the ‘Detailed Description—Preferred Embodiments’: Sections regarding FIGS. 19A and 19B are about lock holders in general and sections regarding FIGS. 19C to 19J are specifically about Double Lock Holders 48. Portions of this text refer to “Lock Holders 31 and 48” referring to both Lock Holders 31 and Double Lock Holders 48, when a reference is made to lock holders in general, irrespective of how many locks they may hold.

49 Clip—A clip, as used by this invention, is a fastener that partially surrounds and holds a component of a lock or lock holder. It can be attached to any part of one lock (or lock holder), directly, or with the use of a Cord 50 or Strap 51. Clips can be used in conjunction with other components in order to either assist in securing locks together, or locks to a lock holder, or locks to an independent component, or they can be used along with Cords 50 and/or Straps 51 as the primary means to connect two or more locks together. In some instances a Sleeve 24 may replace a clip and serve a similar function.

50 Cord—A cord is a flexible connection used to attach two components. It can be made from many materials including, but not limited to shock cord, bungee cord, rubber, Polypropylene, as well as cotton, nylon and polyester rope. A cord can be attached to a component and serve as a flexible extension used for fastening items, or it can be an independent component that is used to secure other items.

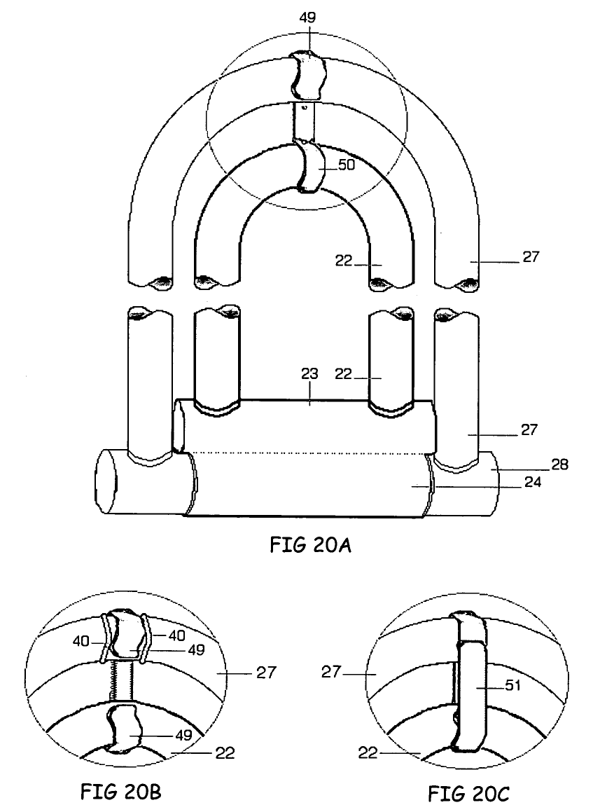

51 Strap—A strap is a flexible piece of material that is used for binding items together. As used by this invention, a straps is similar to a cord 50 in that it can be attached to a component and serve as a flexible extension used for fastening items, or it can be an independent component that is used to secure other items. Straps can be bound around components of a lock, or lock holder and either secure these items independently on one end of the strap, or they can enclose both items and be bound to themselves as seen in FIG. 20C.

52 Hinge—A hinge is a movable joint that fastens two components such that they may pivot, rotate or swing in relation to one another, around a fixed axis.

### DRAWINGS—OTHER KEY POINTS

When looking at this invention, the primary use of the locks will be similar to the use and description of any other U-shaped lock as well as many other similar security/utility locks. The convenience of having a second, or even more, locks available gives this invention advantages and added value over other such locks. Where the locks in this invention differ from other locks is in the connecting, combining or fitting together of the locks for storing and traveling purposes.

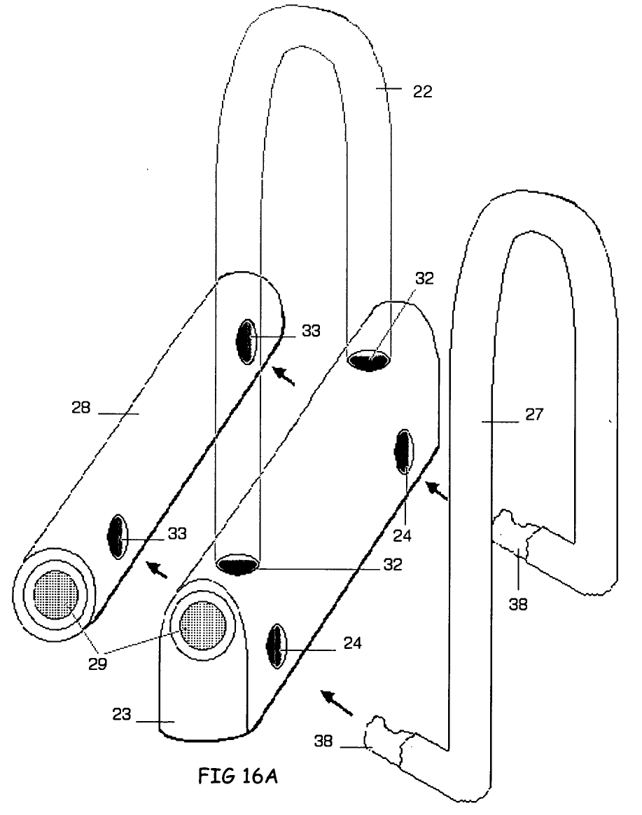

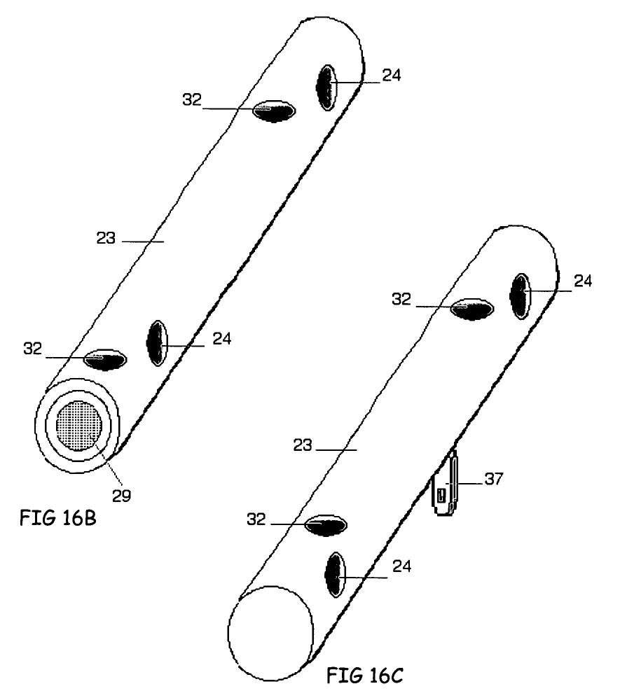

For ease of description, I will most often describe the linking or connection between just two locks: an Inner U-Shaped Lock 21 and an Outer U-Shaped Lock 26; side-by-side locks, (such as FIGS. 16A, 17A and 17B); or, locks connected by additional components such as a Sleeve Bar 43 or a Lock Holder 31 or 48. FIGS. 15A and 15B are examples where I consider multiples of 3 and 4 locks respectively.

Regardless of which connected lock(s) have the necessary tabs, sleeves or grooves, for securing the two locks together, the Inner U-Shaped Lock 21 is usually, but not necessarily always, put in its' locked position first, then the Outer U-Shaped Lock 26 is placed over top of, around, or adjacent to the Inner U-Shaped Lock 21 such that it fits into the sleeves, tabs, or grooves, or other components described herein, and then the Outer U-Shaped Lock 26 is closed and locked. Once both locks are connected together in their locked positions, they will not be able to move independently of one another. Note that in some instances if the Inner U-Shaped Lock 21 fits into the sleeves, tabs or grooves of the Outer U-Shaped Lock 26, then the Inner U-Shaped Lock 21 might need to be placed into these sleeves etc. before being locked, (see FIG. 13A). This would also be necessary if there are sleeves on an independent component or lock holder.

For all lock groupings or combinations shown in the Figures, both locks require a key, and for the benefit of ease of use and practicality, (although not necessary), both locks can use the same key.

### DETAILED DESCRIPTION—INTRDUCTION TO PREFERRED EMBODIMENTS

Note: Some descriptions and operations have already been included in the previous sections, ‘Drawings—Detailed Description Of Reference Numerals’ and ‘Drawings—Other Key Points’.

About The Preferred Embodiments—have invented an improved lock, used primarily for bicycle security as well as other recreational possessions, featuring a second lock, and potentially more locks, which are fastened to, or connected within the confines of, the first lock when these locks are not in use. Although I will primarily focus on the concept of just two U-Shaped Locks, other embodiments and lock styles will be described in further detail.

A U-shaped lock, hereafter named the Inner U-Shaped Lock 21, is secured within, or adjacent to, another U-shaped lock, hereafter named the Outer U-Shaped Lock 26, in order to provide the convenience of two locks, while being stored within a space not significantly greater than the space required to store just one U-shaped lock.

The Inner U-Shaped Lock is secured or connected to the Outer U-Shaped Lock, (or two locks are connected or secured next to each other), by one of five primary means, with other variations, combinations and adaptations shown in the accompanying Figures and described in further detail in the accompanying text.

Each of the five primary means for connecting a plurality of locks have their own Preferred Embodiments. The five primary means for connecting locks together for convenient storage are:

1. The use of Sleeves 24

2. The use of Tabs 25

3. The combination of varied embodiments of primary means 1 and 2 above.

4. The use of primary means 1, 2, and/or 3 to secure locks side-by-side.

5. The use of a component(s) independent of the locks.

### DETAILED DESCRIPTION—PREFERRED EMBODIMENTS

The following Preferred Embodiments are described according to the primary means by which they connect two or more bicycles together for convenient storage. References to all Figures are elaborated on in the next section, in order by Figure number. When considering the following Preferred Embodiments, certain changes may be made in the present disclosure without departing from the scope of the present invention, it is intended that all matters described in the foregoing specifications or shown in the accompanying drawings, be interpreted in an illustrative and not limiting sense.

This invention discloses five primary means for connecting locks together for convenient storage. The five primary means are:

1. The use of Sleeves.—Sleeves 24 as described in ‘Drawings—Detailed Description Of Reference Numerals’ are used to connect two or more locks together. Description with examples:

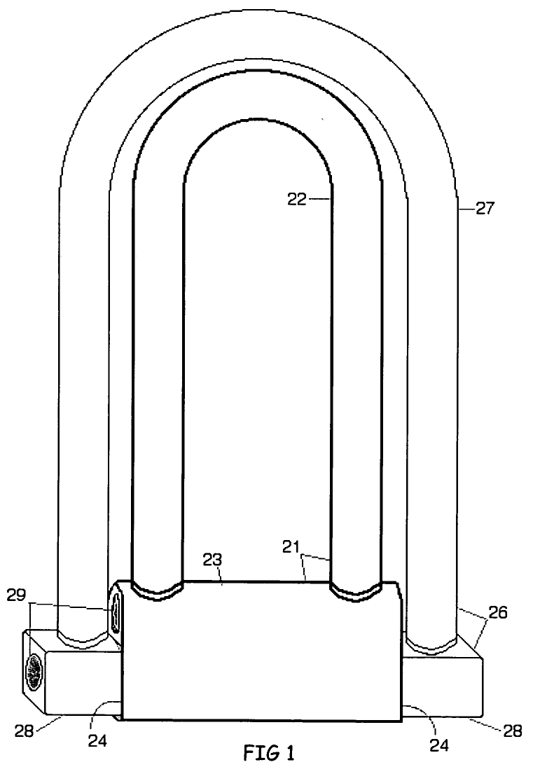

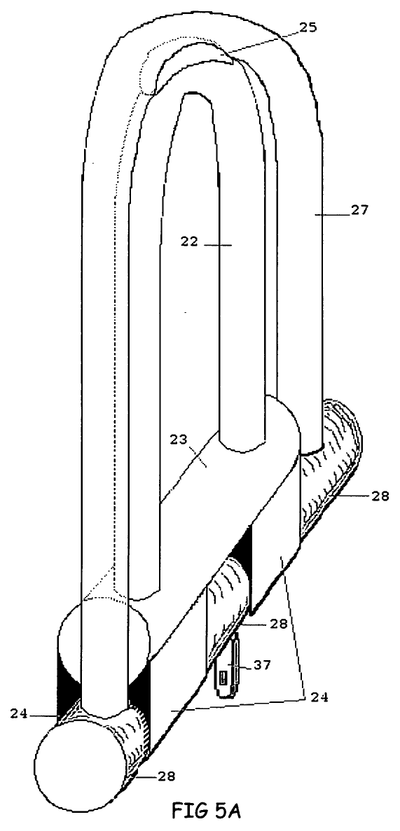

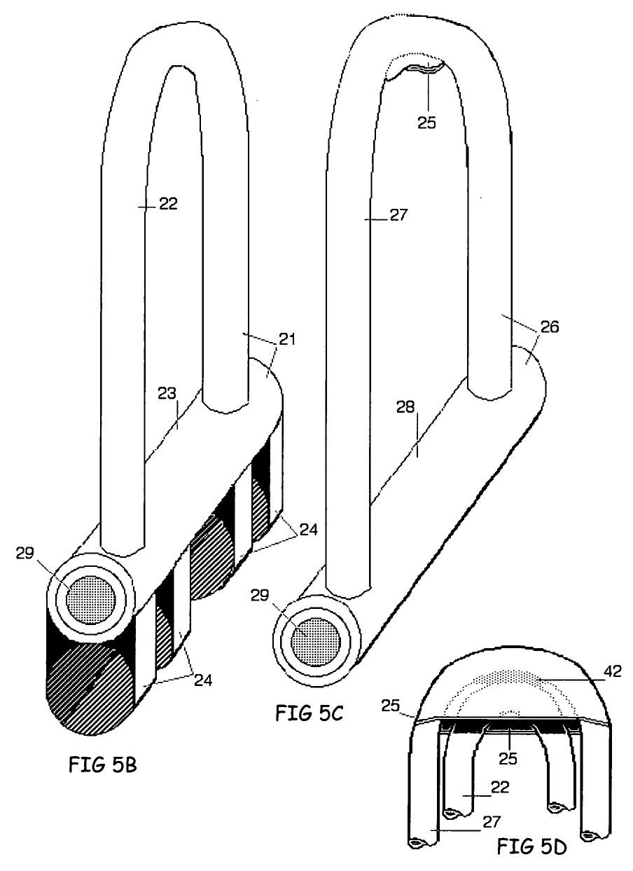

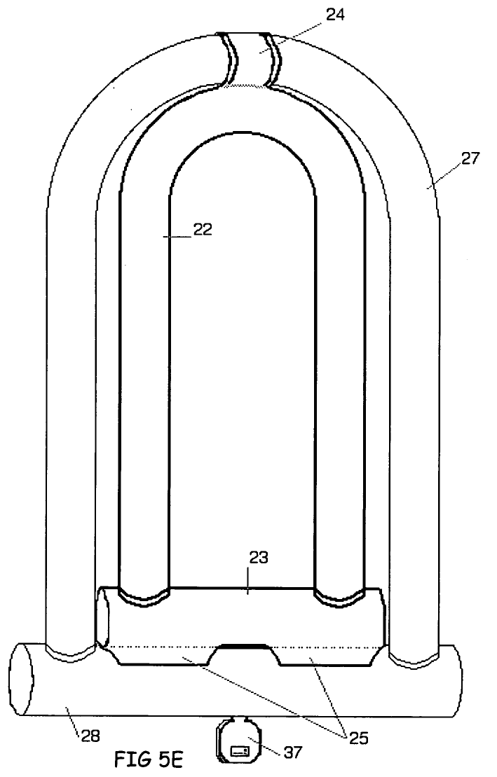

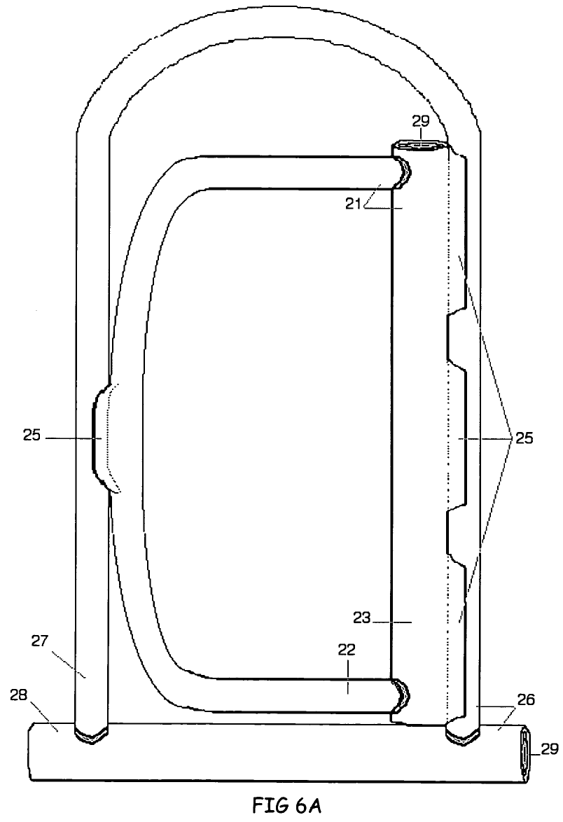

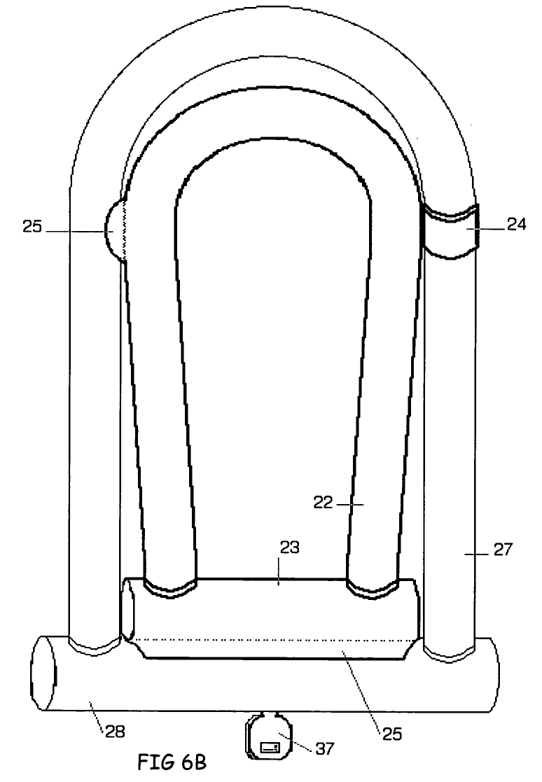

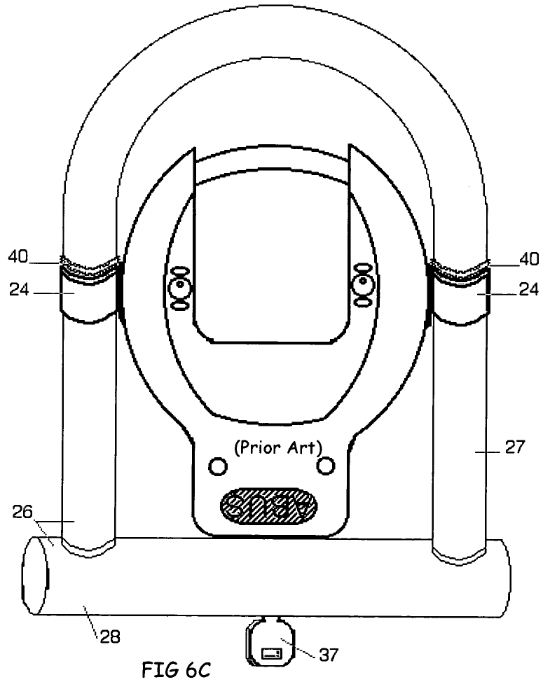

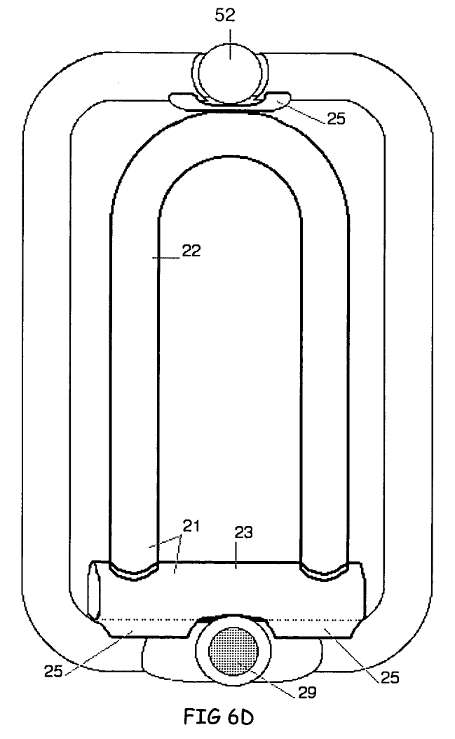

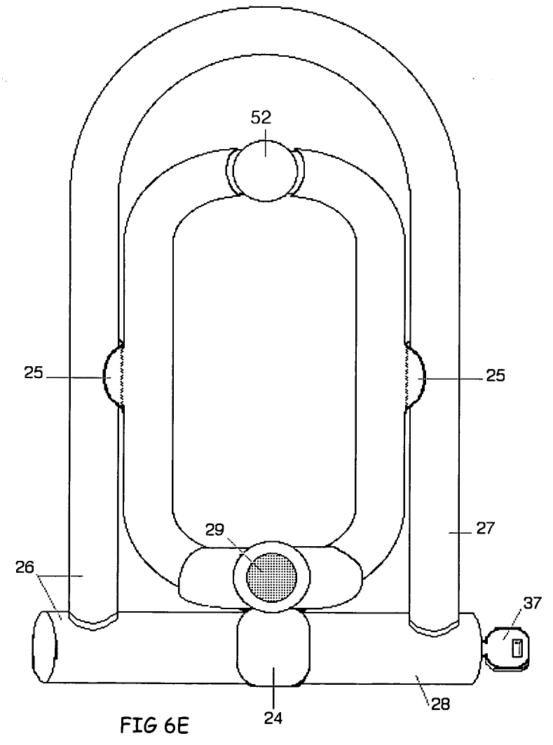

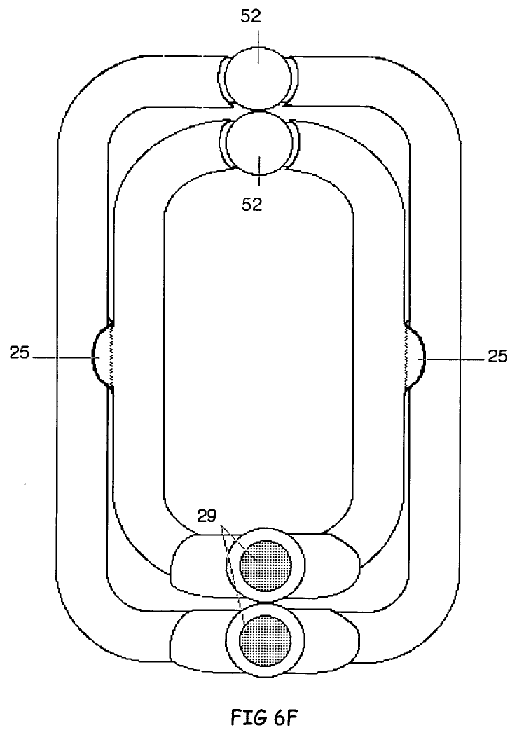

In FIG. 1 the Inner U-Shaped Lock 21 has the Sleeve 24, (or sleeves as seen in FIGS. 5A and 5B). These figures have the sleeve below the Cross Bar 23, (which houses the lock case and locking mechanism 29). The Cross Bar 28 of the Outer U-Shaped Lock fits securely within the sleeve(s) 24 so that it may not move freely once the U-shaped shackle 27 of the Outer U-Shaped Lock 26 is locked over top of the locked U-Shaped Shackle 22 of the Inner U-Shaped Lock 21. The sleeve can also be secured to other lock components, and other lock components can fit into the sleeve, such as the Inner Cross Bar 23, or one of the U-Shaped Shackles 22 or 27, see FIGS. 5E and 6B.

2. The use of Tabs.—Tabs 25 as described in ‘Drawings—Detailed Description Of Reference Numerals’ are used to connect two or more locks together.

Description with examples:

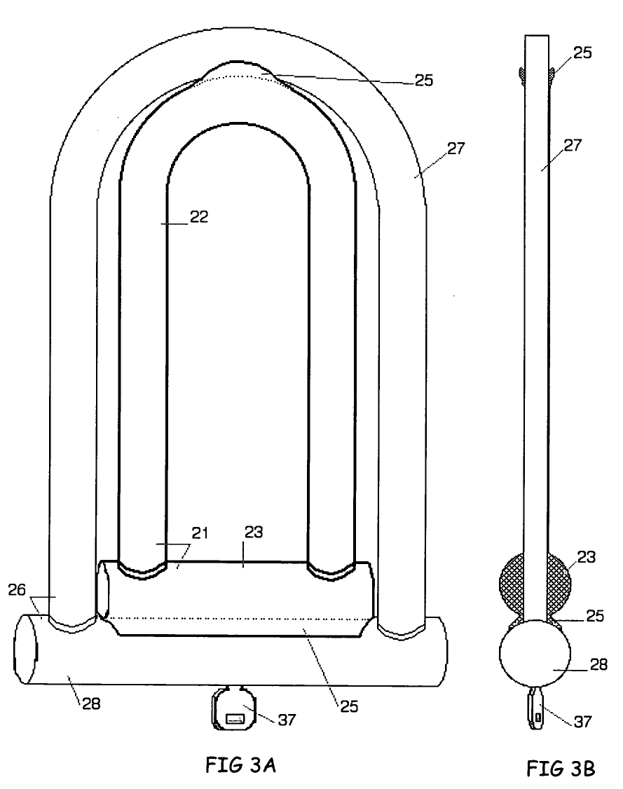

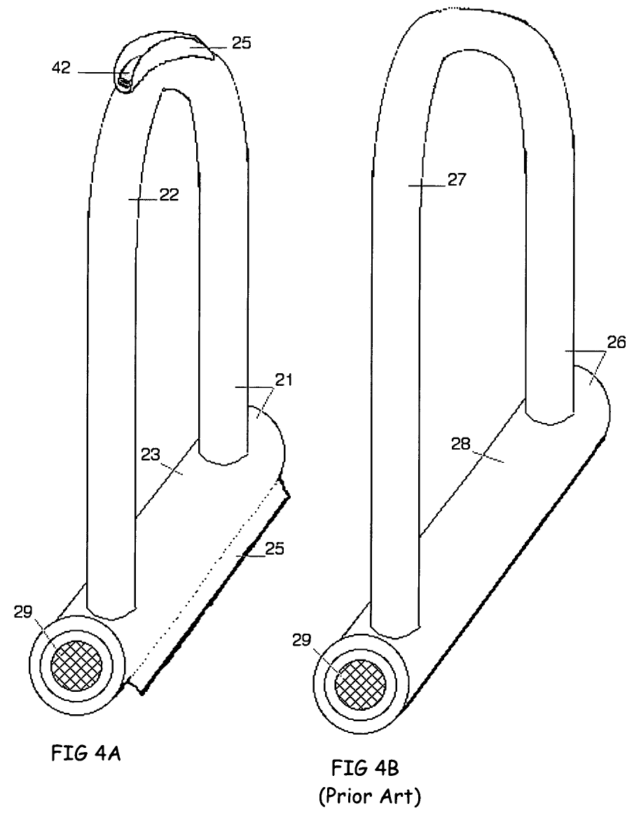

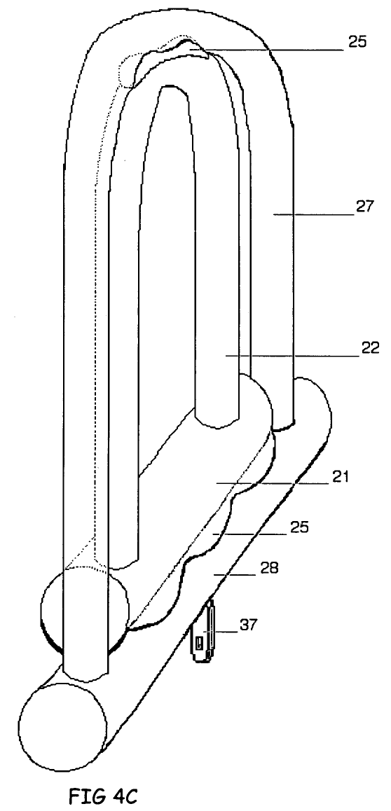

In FIG. 4A the Inner U-Shaped Lock 21 has Tabs 25 that extend and hold this lock within the Outer U-Shaped Lock 26, (FIG. 4B). When the locked Inner U-Shaped Lock 21 is fitted within the locked Outer U-Shaped Lock 26, the said Tabs 25 fixed to the Inner U-Shaped Lock securely confines the Inner U-Shaped Lock 21 within the Outer U-Shaped Lock 26 such that it may not move freely (see FIGS. 3A and 3B). Tabs may also be placed on the Outer U-Shaped Lock, (see Tab 25 in FIG. 5D), or on a Tab Extension Arm 44, (See FIGS. 18A to 18D), or on independent components used to secure two or more locks together.

3. The two locks are secured together by a combination of means listed in Section 1 and/or Section 2 above, or in combination with additional tongues, grooves and/or Rings, (all of which have previously been categorized as members of either the Sleeve 24 or the Tab 25 family in their respective sections within ‘Drawings—Detailed Description Of Reference Numerals’).

Description with examples:

FIG. 5A combines a Tab 25 with Sleeves 24 to secure the locks together. Also, in FIGS. 9A and 9B, Grooved Ends 36 on the outer ends of the Inner U-Shaped Lock's Cross Bar 23 fit securely into the Outer U-Shaped Shackle 27, while an optional Tab 25 secures the arcs of the two U-Shaped Shackles (22 and 27) together. A version of Ridged Rings 40, (which can also be considered Grooves 35 of a Tongue 34 and Groove 35 assembly), can be seen in FIG. 14.

4. The use of any of the above means, mentioned in section 1, 2 and/or 3 above, in order to link two, (or more), locks side-by-side. Side-by-side or tandem locks are secured or held together, or partially nested, when not in use, so that they cannot move independently and so they can be easily stored together. These differ from some of the above mentioned combinations of locks by their relationship in location to one another, (connected next to each other rather than connected with one lock within the confines of another), but still use any of the means of connecting locks together as described above, as well as in section 5, below.

Description with examples:

In FIG. 17A sleeves on the Outer U-Shaped Cross Bar 28 hold the Cross Bar 23 of the Inner U-Shaped Lock 21 adjacent to it such that the locks are secured side-by-side. Also see FIG. 16A.

5. The use of an independent component, and/or Clips 49 and/or Straps 51, and/or a Lock Holder 31, or a Double Lock Holder 48 to hold or secure the locks together when the locks are not in use. The locks themselves can be, (but are not necessarily), connected together, instead, they are connected together by means of an independent component. Independent components can house any of the other components mentioned in the primary means 1, 2, 3 and/or 4 mentioned above.

Examples of an independent component include:

A Sleeve Bar 43, that holds the locks side-by side. Two variations can be seen in FIGS. 17B and 17E;

A Clip 49 or clips, that secures the two locks together either independently using two or more clips, or in conjunction with other components mentioned in these primary means, as seen in FIGS. 20A to 20C. Straps 51, (as seen in FIG. 20C), are a form of Clips 49 in as much as they are fasteners that secure components of the lock(s); A combination of an Independent Sleeve Bar 43 and Lock Holder 31, as seen in FIGS. 17C to 17E);

A Double Lock Holder 48, as seen in FIGS. 19C, 19D, 19G and 19I.

In many instances, a combination of these five primary means of securing and/or storing locks together proves beneficial in order to reduce the opportunity for the locks to shift, move or rattle when secured on a moving bicycle or other vehicle.

Variations—Many variations will be further described that may vary slightly from these primary means, including the use of grooves, ridges or tongues, (all described as part of the tab family), as well as clips, cords, and straps. Some of these will be the primary means which in turn require the use of other means mentioned as secondary, essential, or optional means to assist in securing the locks together. However used, these means all share the common goal of this invention: to connect two or more locks together to gain the advantage of having more than one lock stored conveniently and compactly together when not in use.

U-Shaped Locks—U-shaped locks are considered herein, however as mentioned previously other lock styles are possible and examples are provided to add alternate shaped locks to the scope of this invention, as clearly demonstrated in FIGS. 6A to 6G.

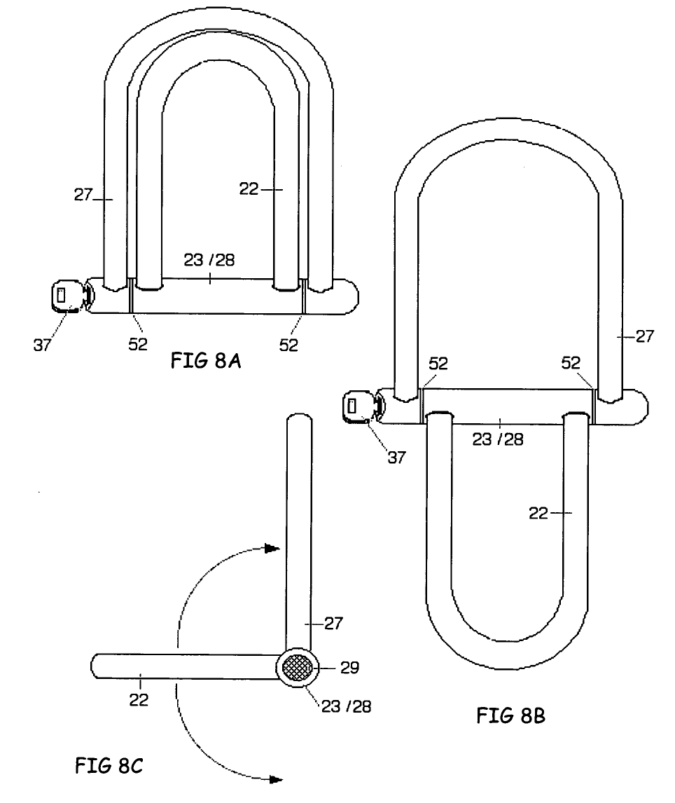

Although in this invention the U-shaped locks are secured together when not in use, they are two separate U-shaped locks that work independently, (with the exception of the lock seen in FIGS. 8A to 8C), and therefore they provide superior convenience and security compared to a single, conventional U-shaped lock. Since two independently working U-shaped locks are required, this invention has great potential to be used to fit an existing U-shaped lock, that a customer has already purchased, with an additional Inner U-Shaped Lock, (or possibly an additional tandem lock or Outer U-Shaped Lock). This would allow a lock manufacturer to produce added value to pre-existing customers, and therefore produce greater revenue, by selling, for example, an Inner U-Shaped Lock that fits into their historically best selling U-shaped lock(s), or a single lock with a double lock holder, such that a second, already purchased, lock can be stored adjacent to this new lock. This is advantageous since there are a considerable number of U-locks currently owned by consumers worldwide, and this invention would be appealing to pre-existing U-lock consumers.

### DETAILED DESCRIPTION—PREFERRED EMBODIMENTS

The following Preferred Embodiments are detailed descriptions of the Figures in the order that they appear. Details concerning these figures are to be interpreted in an illustrative and not a limiting sense.

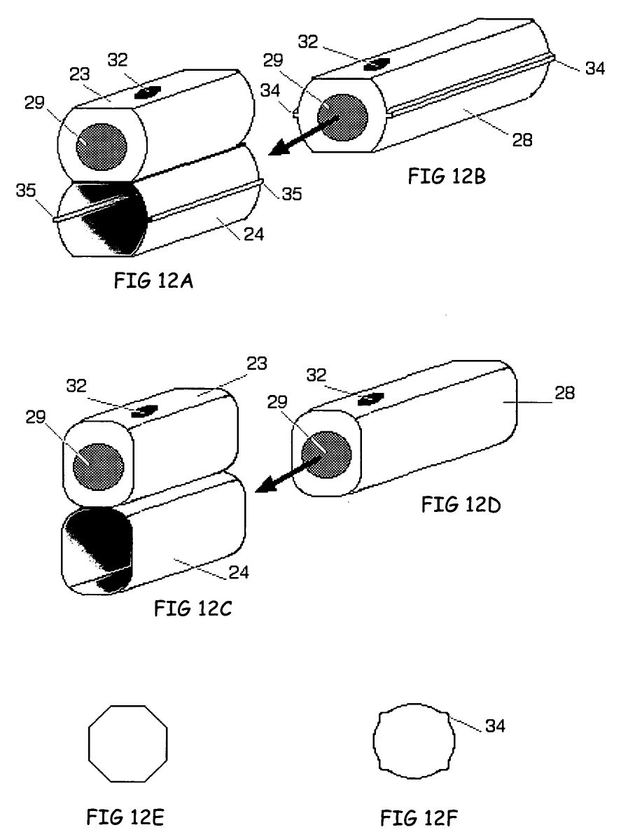

FIG. 1 is a representation of the sleeve variation of this invention. It is of two U-Shaped Locks, the Inner U-Shaped Lock 21 and the Outer U-Shaped Lock 26, from their sides, when locked together. The Inner U-Shaped Lock 21 has two basic components that assemble to make the lock functional, the Inner Cross Bar 23 and the Inner U-Shaped Shackle 22, and the Outer U-Shaped Lock 26 has two basic components that assemble to make the lock functional, the Outer Cross Bar 28 and the Outer U-Shaped Shackle 22. In FIG. 1 the Inner U-Shaped Lock 21 is locked first, then the Outer U-Shaped Lock's Cross Bar 28 fits securely into the Inner U-Shaped Lock's Sleeve 24 before being locked. The two locks cannot move freely when both locks are secured together as shown. The variation shown in FIG. 1 has the Outer U-Shaped Lock 26 with a square Cross Bar 28 that fits securely into a square Sleeve 24 below the Inner U-Shaped Lock's Cross Bar 23 which, like other shaped sleeve and cross bar variations (see FIGS. 12A to 12F), restricts the two locks from becoming un-aligned when they are secured together.

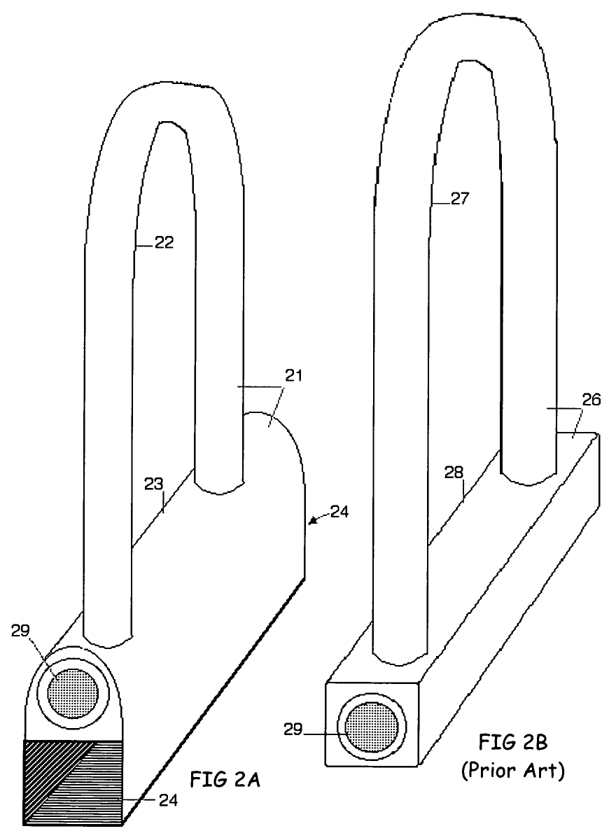

FIGS. 2A and 2B are representations, in perspective view embodying a Sleeve 24 variation. They are independent representations of the same two locks shown connected together in FIG. 1. These figures show that, when separated, the two locks are fully functional and independent from one another.

Furthermore, although not shown, locks that do not have a uniform sized cross bar from one end to the other could still be secured by a Sleeve 24, (note: U.S. Pat. No. 5,257,517, (Dale, November 1993) has a large reinforcing shield that begins at the locking case, located at the cross bar end, and continues along the cross bar to encase the nearest aligned opening on the lock's cross bar). In fact, the lack of uniformity could work as an advantage in limiting the Sleeve 24 from rotating freely when fixed over top of the circular or symmetrical cross bar.

FIG. 2A is of the Inner U-Shaped Lock 21 in the closed position and shows specifically that the Sleeve 24 would not hinder the ability of this lock to secure any items.

FIG. 2B is a representation of a conventional U-Shaped Lock, in perspective view of the above mentioned sleeve variation, to be used as the Outer U-Shaped Lock 26, along with the lock in FIG. 2A. The ABUSE Granit series of U-Shaped Locks are examples of conventional locks that have square/rectangular cross bars. (See note in this section under FIG. 4B for benefits of using a conventional lock as one of the two locks). This Outer U-Shaped Lock 26 is not necessarily a conventional lock, and can potentially house other components, such as Tabs 24, as mentioned herein.

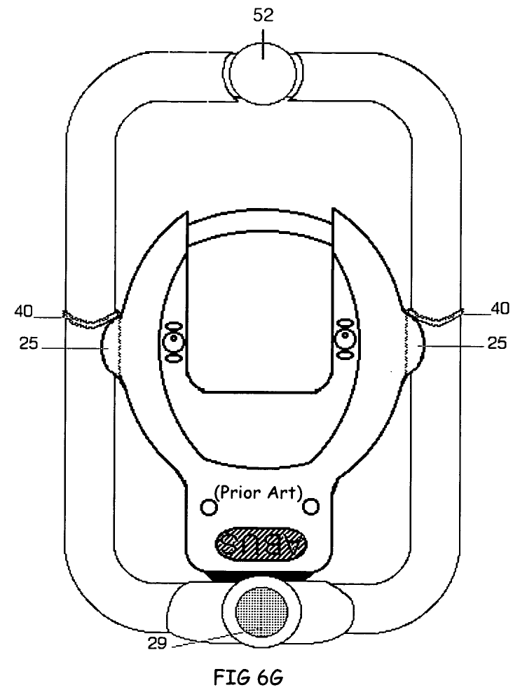

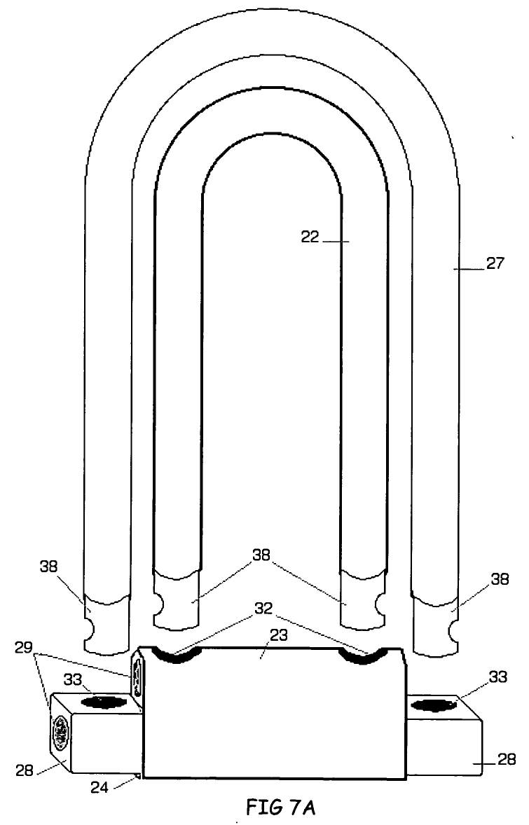

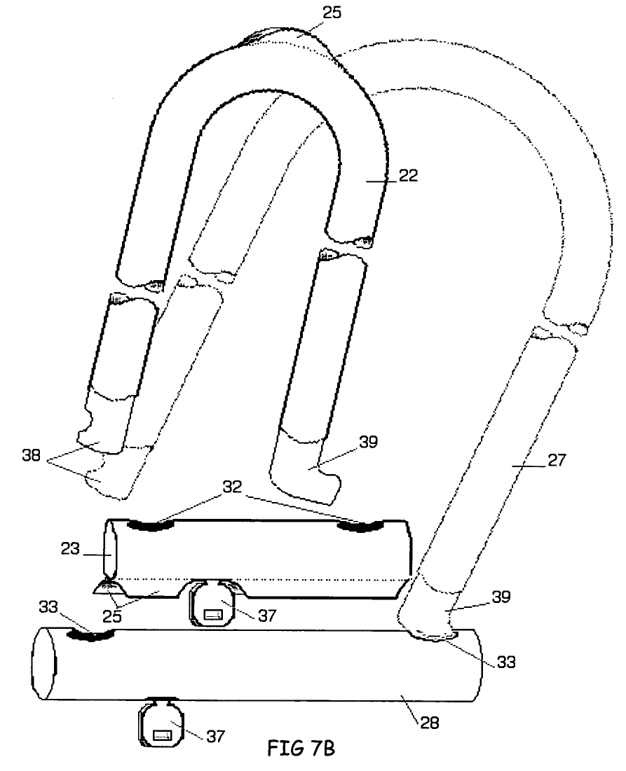

FIGS. 3A and 3B are representations of a tab variation of this invention. These figures show an alternate location (compared to FIGS. 1 and 2) for the Lock Case and Locking Mechanism 29, (not shown, but the location is represented by the positioning of the Key 37), at the bottom, middle, center of the Cross Bar 28. Another alternate location for the locking mechanism is in a similar location at the bottom of the cross bar except closer to the anterior side of either one of the two aligned openings for the U-shaped shackle, (See the Key 37 location in FIG. 7B).

FIG. 3A is a representation embodying the tab variation. It is of two U-Shaped Locks, the Inner U-Shaped Lock 21 and the Outer U-Shaped Lock 26, from their sides, when locked together. This drawing shows one Tab 25 extending across the curve of the U-shaped shackle and a second tab is placed across almost the entire width of the Inner U-Shaped Lock's Cross Bar 28 between the Aligned Openings 33 (not shown, but can be seen in FIGS. 7A and 7B). FIG. 5E shows that a Tab 25 across the entire inner length of the Outer Cross Bar 28, as seen here, is simply one variation and not necessary to maintain the functional aspects of the tab. There are a multitude of possible variations, using tabs of various lengths and widths to secure two locks together when they are not in use. Either of the locks can house its' locking mechanism 29 in the same location as shown by the Key 37 on the Outer lock in this figure, or in a different location, including on one of the ends of the cross bars as seen in FIG. 4A.

FIG. 3B is a representation embodying a view perpendicular to FIG. 3A, revealing how the Tabs 25 on the Inner U-Shaped lock 21 secure themselves on to the Outer U-Shaped Shackle 27 and the Outer Cross Bar 28 of the Outer U-Shaped Lock 26. There may be some friction-reducing High Compression Foam 42 attached to the inner curve of the Tabs 25 and compressed between the two locks when they are secured together, see FIG. 4A.

The Inner Lock 21 could be placed in an opposing direction to the Outer Lock 26 such that the outer arc of the Inner Cross Bar 22 has a Tab 25 that rests against the inside of the Outer Cross Bar 28, (See FIG. 9D for one possible embodiment of this alternate positioning).

FIG. 4A is a representation, in perspective view embodying the tab variation. It is of the Inner U-Shaped Lock 21 in the closed position. One option for Tab 25 variations of this invention is to place some High Compression Foam 42, or other padding, inside the Tab(s) 25 at the upper, curved end of the U-shaped shackle, or in any or all tab locations. This would reduce friction and movement, so that the two locks do not rattle or shift independently when stored on a moving bicycle. As well, this cushioning material can compensate for an allowable size tolerance between the two locks.

FIG. 4B is a representation, in perspective view of the tab variation, embodying a conventional U-Shaped Lock, used as the Outer U-Shaped Lock along with FIG. 4A. Like many of these variations, only one lock requires the additional components of this invention in order to connect the two locks. Although both the Inner and Outer locks can house tabs and other additional components the figures mainly focus on the Inner lock (as seen in FIG. 4A) housing the components, since housing them on the Outer lock may hinder the use or available space of the Outer lock. This does not, however, limit the variations of this invention to only being placed on the Inner lock and some, or all, of the components may be placed on the Outer lock in other variations, see FIGS. 5C and 5D.

There are considerable benefits in being able to use a conventional lock along with a lock that houses all the necessary components of this invention, (or an additional component or lock holder that houses all the necessary components of this invention), rather than the addition of this inventions' components to both locks. The two primary benefits of using at least one conventional lock are: that this invention can be used with, and sold either in conjunction with or separately from, a large number of conventional locks that are already on the market (including from competing brands), in order to complete the set of locks; and, the production costs could be significantly lower since only one lock requires different manufacturing than what is currently in production.

FIG. 4C is a representation, in perspective view embodying a Tab 25 variation of this invention. The near side of the Outer U-Shaped Shackle 27 is drawn transparent. This figure serves to demonstrate that the added components can have more decorative design aspects while still serving their function of connecting two independent locks together, (also note the design of FIG. 5B for a decorative design of a Sleeve 24 variation). Lock Holders 31 and 48, and added components that connect the locks side-by-side, or in an alternate way to what is shown, can also have decorative design aspects as well.

The use of Tabs 25 to secure a second lock would be one of several convenient methods to use with Bike Guard® Lock Jaw and Bonelocks as well as The Club®'s Ultra Bike Club™ since the hinges 52 as well as the curves of these oval-shaped locks would make Tabs 25 more convenient than Sleeves 24. See FIG. 6F which uses Tabs 25 and has a Lock Jaw Style Lock as both the Inner and the Outer Lock, (also see ‘Lock Jaw’ style locks with Tabs 25 in FIGS. 6D, 6E, and 6G).

FIG. 5A is a representation embodying the combination of sleeve and tab variations. It is of two U-Shaped Locks, the Inner U-Shaped Lock and the Outer U-Shaped Lock, in perspective view, when locked together. The near side of the Outer U-Shaped Shackle 27 is drawn transparent. In this variation the space between the two Sleeves 24 on the Inner U-Shaped Lock's Cross Bar 23 permits the Lock Case and Locking Mechanisms 29, (not shown, but the location is represented by the positioning of the Key 37), to be placed on the center, bottom of both Cross Bars, (23 and 28), (although as previously stated, other locations are also possible). In this variation the Tab 25 is recommended since the Outer U-Shaped Lock has a circular Cross Bar 28, permitting the Inner lock to rotate freely around the Outer U-Shaped Lock's Cross Bar 28 if not restricted by this tab or by means of the Lock Holder 31 or 48, or by another component, some of which are shown below, see FIG. 5D, (also see FIGS. 12A to 12F).

FIG. 5B is a representation, in perspective view embodying a combination Sleeve 24 and Tab 25 variation. It is of the Inner U-Shaped Lock in the closed position. The number, size and location of Sleeves 24 and Tabs 25 may vary for both design and decorative purposes as long as they serve the purpose of holding, securing or connecting the two, (or more), locks together when the locks are not in use. In this representation, there are four Sleeves 24 located on the circular Inner Lock's Cross Bar 23. Since the Cross Bar is circular and there are no Tabs 25 located on this lock, there is a Tab 25 present on the Outer Lock, as represented in FIG. 5C. This tab keeps the two locks fixed in their desired position, similar to the position seen in FIG. 5A. It may be preferable to have a Tab 25 located on the Inner lock, on the U-Shaped Shackle 22, (as shown in FIG. 5A) since in this location it is completely out of the locking space of the Outer U-Shaped Lock 26 unlike FIG. 5C. It may also be preferable to have the tab on the Inner Lock, since this would make it possible for the Outer Lock to be a conventional, (perhaps even already purchased), U-Shaped Lock, thus the Inner Lock can be sold together or separately to retro-fit an already existing and popular lock to be used as the Outer Lock 26.

FIG. 5C is a representation of the Outer U-Shaped Lock 26, in perspective view, to be used along with the combination Sleeve 24 and Tab 25 variation shown in FIG. 5B, (described above). The location of the Tab 25 on the inside arc of the Outer Lock's U-Shaped Shackle 27 has two possible advantages compared to placing this Tab 25 on the outside of the arc of the Inner Lock's U-Shaped Shackle 22, (FIG. 5A). First, the Tab 25 located here may protect the Tab from unnecessary bumping and wear, (as well as other bicycle components from bumping a Tab 25 that faces outward), and secondly it can also help to protect the optional, friction-reducing, High Compression Foam 42 placed within the Tab 25 to reduce movement between locks when they are stored together. Both FIGS. 5B and 5C show the Locking Case and Locking Mechanism 29 on the outer ends of the respective Cross Bars, (23 and 28), unlike another alternate position shown in FIG. 5A.

FIG. 5D is another representation of a Tab 25 variation on the inside arc of the Outer Lock's U-Shaped Shackle 27. It is a fragmentary perspective of the two U-shaped Shackles, 22 and 27, with a full view of the front/outer, near side Tab 25 as well as the lower back/inside of the tab on the other side of the lock also showing. The Tab 25 is exaggerated in size for clarity and the front Tab is translucent to show the positioning of the Inner Lock's U-Shaped Shackle's 22 arc and optional High Compression Foam 42. This tab variation has some benefits to other variations: For example, it can be made with a solid steel plate on each side of the locks' arcs for durability; It can be significantly small, (as little as ¼-⅜ of an inch), therefore minimizing the amount of space in the Outer Lock that is not available; And, it can house the High Compression Foam 42 used to reduce the opportunity for the two locks to rattle or shift independently when stored on a moving bicycle. This location would protect the High Compression Foam 42, or other cushioning material very well since it would not be exposed to anything other than the Inner Lock's arc, when connecting the two locks together.

FIG. 5E is a representation embodying the combination Sleeve 24 and Tab 25 variation. The width of the Sleeve 24 is dependent on the arc on the Outer U-Shaped Shackle 27 since the sleeve must slide up the shackle leg and along the arc to its' apex. This figure reverses the positioning of the Tabs 25 and Sleeves 24 in FIG. 5A. In both of these variations it is possible to use, friction-reducing, High Compression Foam 42 inside the Tab(s) 25 in order to reduce the ‘play’ or movement between the locks when they are secured together. The difference in Tab 25 shape between FIGS. 5C to 5E and the difference in Sleeve 24 shape between FIGS. 5A, 5B and 5E further emphasizes that the idea of using Tab(s) 25 and Sleeve(s) 24 allows a variety of shapes that are not limited strictly to those represented in the Figures herein.

FIG. 6A is a representation embodying the Outer Lock 26 and an alternate shaped, connected Inner Lock 21. This figure introduces the idea of having Tabs 25 on the Inner Lock's Cross Bar 23 fit around or rest against a leg of the Outer U-Shaped Shackle 27 (see also FIG. 15B), rather than onto the Outer Cross Bar 28, (see FIG. 3A). The Lock Case and Locking Mechanisms 29 are located on the ends of the Cross Bars 23 and 28 in this figure, but they can be placed elsewhere on the cross bars as well. Furthermore the Lock Case and Locking Mechanisms 29 on the Inner Lock 21 can be positioned on the end placed closest to the Outer Cross Bar so that it is shielded for dirt and debris when the locks are stored together, (these can also be shielded by a variety of conventional lock covers, not shown), or it can be placed along the base of the cross bar as seen in other figures. There are numerous shapes that both the Inner Lock 21 and the Outer Lock 26 can have that allow two locks to be connected together when not in use, some of which are shown below. Furthermore, even designs not yet conceived of could still be connected using the components of this invention.

FIG. 6B is a representation embodying an alternate, (prior art), ‘magnet’ shape for the Inner Lock's Shackle 22. It shows two options for securing the locks together. Both of these options include a Tab 25 on the Inner Lock's Cross Bar 23. The tab could vary in size, or it could also be replaced by a Sleeve 24, Grooved Ends 36, or another component mentioned herein. One option shown, on the left side of the Inner Shackle 22, just below the arc, is the use of a Tab 25 to secure the Inner Lock's Shackle 22 relative to the Outer Lock's Shackle 27. It is possible to have just one Tab located here, or a second Tab located where the Sleeve 24 is located in the figure. The other option shown, on the right side of the Inner Shackle 22, just below the arc, is the use of a Sleeve 24 to secure the Inner Lock's Shackle 22 relative to the Outer Lock's Shackle 27. It is possible to have just one Sleeve located here, or a second Sleeve located where the upper Tab 25 is located in the figure. It would also be possible to combine Sleeves 24 and Tabs 25 in a variety of ways one of which is suggested in the figure.

[A ‘magnet’ shaped lock can be seen in FIG. 13 of U.S. Pat. No. 4,155,231, (Zane, et al., May 1979)].

FIG. 6C is a representation embodying the Outer Lock 26 and a, (prior art), ABUS® Protecta UB (NKR) Frame Lock as the Inner Lock. The ABUS® Protecta UB (NKR) Frame Lock is secured to the Outer Lock 26 by two of this invention's Sleeves 24 that are attached/joined to the ABUS®. To hold the locks in place, the Sleeves 24 slide onto the Outer Lock's Shackle 27 legs and the flat base, (at the top of the upside down ABUS® lock) is butted against the Cross Bar 28 of the Outer Lock 26. Ridged Rings 40 located on the Outer Lock's Shackle 27 legs restrict the ABUS® lock from moving away from the Cross Bar 28, thus restricting movement between the locks when they are secured together. The ABUS® Protecta UB (NKR) Frame Lock is just one of many Frame Locks that could be secured to the Outer Lock in a variety of ways similar to this. As well, handcuff style Cuff Locks such as those sold by Master Lock® could also be stored in a similar way.

FIG. 6D is a representation embodying the Inner U-Shaped Lock 21 and a, (prior art), Bike Guard® Lock Jaw Style Lock, assembled as a single unit with a Hinge 52, as the Outer Lock. Other locks by Bike Guard® including the Lock Jaw 2000 and the Lock Jaw 1200, as well as the Bike Guard® Bonelocks could also serve as possible Inner, Outer, or adjacent locks. Furthermore locks such as these could also be connected/secured together, (with either two similar locks or two different designs), using a Double Lock Holder 48 such as the ones seen in FIGS. 19C, 19D, 19G and 19I. These locks could also be connected by other means mentioned herein.

FIG. 6E is a representation embodying the Outer Lock 26 and a, (prior art), Bike Guard® Lock Jaw Style Lock as the Inner Lock. The Lock Jaw Style Lock is secured to the Outer Lock 26 using a combination of Tabs 25 and Sleeves 24. This connecting of locks, as well as those in FIG. 6D above, can be secured together by: just using either tabs or sleeves; by adjusting the location of the tabs and/or sleeves; and even by adding other components such as a Tongue 34 and Groove 35 assembly or a Ridged Rings 40 (as seen in FIG. 6C above).

FIG. 6F is a representation embodying both the Inner and Outer Lock that are, (prior art), Lock Jaw Style Locks. This is the first of two figures that demonstrate the versatility of this invention beyond the use of U-Locks. The locks are secured together by Tabs 25, but they can also be secured together by other means mentioned above in the description for FIG. 6D as well as other means mentioned herein. It would also be possible to secure the locks such that the Hinge 52 of the Inner Lock is butted against the lock of the Outer Lock and vice versa, (see FIG. 9D for a U-lock version of this). Furthermore, a third lock could be placed within the confines of the Inner Lock in this and other variations.

FIG. 6G is a representation embodying a, (prior art), ABUS® Protecta UB (NKR) Frame Lock, (also seen in FIG. 6C), as the Inner Lock and a, (prior art), Bike Guard® Lock Jaw Style Lock, (also seen in FIG. 6D), as the Outer Lock. Not only are these two locks not U-Locks, but they are also of two completely different styles, again demonstrating the versatility of this invention. The ABUS® Protecta UB (NKR) Frame Lock is secured to the Outer Lock Jaw Style Lock by two Tabs 25. The flat base, (at the top of the upside down ABUS® lock) is butted against the Locking Mechanism 29 section of the Lock Jaw Style Lock, and the Ridged Rings 40 located on the Outer Lock Jaw Style Lock restrict the ABUS® lock from moving away from the Locking Mechanism 29 section of the outer lock, thus restricting movement between the locks when they are secured together.

All seven of the above mentioned figures, FIGS. 6A to 6G, and the included descriptions, demonstrate the versatility of the different components described in this text and their ability to connect two or more locks, specifically of different prior art varieties and/or styles, for the purpose of convenient storage when the locks are not in use. A number of flexible locks could also be connected using means described herein, as described in the “Alternate Embodiments” section of this text.

FIG. 7A is a representation embodying the sleeve variation combination of locks in elevation. It is of two U-Shaped Locks, the Inner U-Shaped Lock (parts 22 and 23) and the Outer U-Shaped Lock (parts 27 and 28), both in open position. It reveals, on the ends of the U-shaped Shackles (22 and 27), conventional Straight ‘Feet’ 38 that are grooved. The Grooves are used to secure the U-shaped shackle to each of their respective Cross Bars, 23 and 28. The variety of conventional designs of such feet are extensive but the variety does not hinder the functions of this invention.

FIG. 7B is a representation embodying the tab variation combination of locks in elevation. It is of two U-Shaped Locks, the Inner U-Shaped Lock (parts 22 and 23) and the Outer U-Shaped Lock (parts 27 and 28), in open positions. It reveals, on the ends of the U-shaped shackles, a combination of a grooved, straight ‘foot’ 38 on one end of each of the U-shaped shackle legs and a Bent ‘Foot’ 39 on the other leg of each U-Shaped Shackle, 22 and 27. These ‘feet’ are used to secure the U-shaped shackle to each of their respective Cross Bars, 23 and 28. It may prove more convenient to use a straight foot rather than a bent foot on the Outer U-Shaped Lock, as it may be more challenging to lock a bent foot over top of the Inner U-Shaped Lock. However this does not limit the possibility of using a bent foot on the Outer U-Shaped Lock, and some design variations may even favor it. Note that on this variation the key 37 for the Lock Case and Locking Mechanism 29, (not shown), is located on the bottom of the cross bars 23 and 28, but rather than being centered. The Lock Case and Locking Mechanism 29 are positioned closer to the straight, grooved ‘foot’ 38 end of the U-shaped shackles 22 and 27. Again this demonstrates that this invention can be used with, or manufactured on to, a greater number of conventional locks that are already on the market.

FIG. 8A is a representation embodying two U-Shaped Shackles 22 and 27 with a shared Cross Bar 23/28. This variation has a Hinge 52 component that allows the Outer (and/or Inner) Shackle to rotate a full 360° around the Cross Bar's axis. The locking mechanism can be designed such that the locks can rotate only when unlocked, thus restricting movement of the locks when items are secured and when the locks are stored together in this position or the position seen in FIG. 8B. This embodiment would be useful for locking the bicycle and then securing other items such as a helmet. This can also be accomplished with any of the lock combinations in this patent.

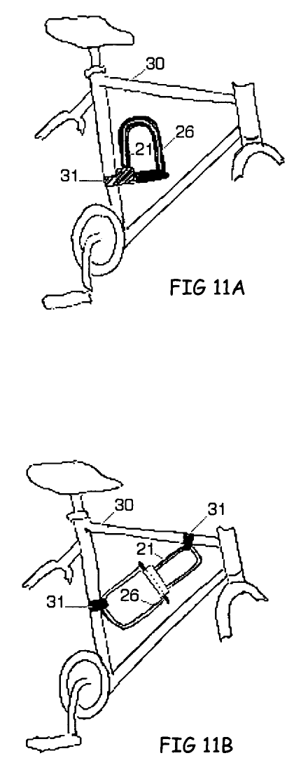

FIG. 8B is a view of FIG. 8A with the Inner Lock Shackle 22 rotated 180° relative to the Outer Lock Shackle 27. A variation of this figure could have the locks fixed in this position rather than hinged. For both of these examples the use of Lock Holders 31 as seen and described in FIG. 11B can be useful. This lock would be useful in either this position or the position seen in FIG. 8C when the user has more than one bicycle to secure. This lock design would be both cheaper to make (only one lock) and lighter than designs with two cross bars.

FIG. 8C is a perpendicular view to FIGS. 8A and 8B with the Inner Shackle 22 turned or pivoted 90° on the Cross Bar's 23/28 axis, (from this figure, rotate the Inner Shackle 90° towards the outer shackle to the position seen in FIG. 8A, (see the arrow above the Inner Shackle 22) or rotate it 90° away from the outer shackle to the position seen in FIG. 8B, (see the arrow below the inner shackle 22)). The lock in this position can be used to secure a bicycle to components of a car rack, or to another bicycle, or perhaps to a secure object not designed for securing bicycles such as an iron fence rail. FIGS. 16A to 16C each have similarities to this variation, however the Outer or Inner Shackles pass through the Cross Bar and lock into a second independent Cross Bar.

Although fundamentally different in design, a lock with similar functioning can be seen in U.S. Pat. No. 5,622,066, (Shallis, April 1997). This lock uses a rigid link added to one of the U-shaped shackle's legs to create a single lock with two U-shaped areas to secure items in.

FIG. 9A is a representation embodying a variation with Grooved Ends 36 located on the Inner Cross Bar 23. It is of two U-Shaped Locks, the Inner U-Shaped Lock (parts 22 and 23) and the Outer U-Shaped Lock (parts 27 and 28), from their sides, when locked together. The lower part of the Outer Shackle 27 legs and the lower part of the right Inner Shackle 22 leg are translucent in order to show the Grooved Ends 36 and the location of the Aligned Opening 32 respectively. In this diagram the Grooved Ends 36 are accompanied by an optional Tab 25 on the outside arc of the Inner U-Shaped Shackle 22. An alternate to the tab seen here could be a small tab on the outer shackle, as seen in FIG. 5C. No tab would be necessary if, (just above where the Inner U-Shaped Lock's Grooved Cross Bar needs to remain stationary), there was a thickening of the legs of the Outer U-Shaped Shackle 27. This thickening can be done any number of ways including a bulge created by the placement of a small Ridged Ring 40 around the Outer U-Shaped lock's U-Shaped Shackle legs, (See FIG. 9C). Furthermore, a tight fit between the two locks may be all that is necessary to secure the locks in conjunction with Grooved Ends 36, especially for rectangular shackles such as the ABUS® Granit X-Plus 54 rectangular parabolic shackle.

In this Grooved Cross Bar Ends 36 variation the lock case and locking mechanism 29 would be more conveniently placed on the length of the Cross Bar 23 rather than on the outside ends where the Grooved Ends 36 are, since a tight fit is recommended between the Inner and Outer locks. These Grooved Ends 36 are a variation of Tabs 25 that are placed on the outside ends of the Inner Cross Bar 23 rather than along the length of the Inner Cross Bar 23 as shown in FIG. 4A. The grooves are a very durable version of Tabs 25, and may or may not be used in conjunction with other tabs, sleeves or other components mentioned herein.

FIG. 9B is another embodiment of the Grooved Cross Bar Ends 36 variation of this invention. It is a fragmentary representation a segment of FIG. 9A. It is of one end of the Inner U-Shaped Lock's Cross Bar 23 seen from an inner, top view. It reveals a possible shape of the Grooved Ends 36 which are used in conjunction with the Outer U-Shaped lock's U-Shaped Shackle 27 legs to secure the locks together. The outer shackles' legs serve as tongues in a similar way to the Tongue 34 and Groove 35 assembly.

FIG. 9C is a copy of one segment of FIG. 9A that has a Ridged Ring 40 added to it. This Ridged Ring 40 can work in conjunction with the Grooved Ends 36 in order to ensure that when the two locks are secured together there is no allowance for the locks to move independently. Like the use of friction-reducing, High Compression Foam 42, these Ridged Rings 40 could eliminate any slack and/or noise related with two locks being stored together on a moving bicycle. Furthermore the optional Tab 25 shown in FIG. 9A may not be necessary with the addition of Ridged Rings 40.

FIG. 9D is a representation embodying a Grooved Cross Bar Ends 36 variation. It is of two U-Shaped Locks, the Inner U-Shaped Lock (parts 22 and 23) and the Outer U-Shaped Lock (parts 27 and 28), from their sides, when locked together. The Inner U-Shaped Lock is inverted so that, when connected, the locks sit in opposite directions. There is a Tab 25 on the outer arc of the Inner U-Shaped Shackle 22 that has the Outer Cross Bar 28 secured in it when the locks are connected. The Grooved Ends 36 rest within the Outer Shackle 27 legs where the legs begin to narrow into the shackle's arc. The arc prevents the Grooved Ends 36 from letting the Inner Lock 21, (and thus the Tab 25 (with optional High Compression Foam 42)), slide away from the Cross Bar 28. Ridged Rings 40 could also be used here.

Just as FIGS. 6A to 6G demonstrate versatility in lock shapes, this figure (and FIG. 15B) demonstrates versatility in lock orientation and/or configuration. Furthermore, the Outer U-Shaped Locks 26 seen in FIGS. 9A and 9D can both be prior art locks that can also be sold independently from the inner locks.

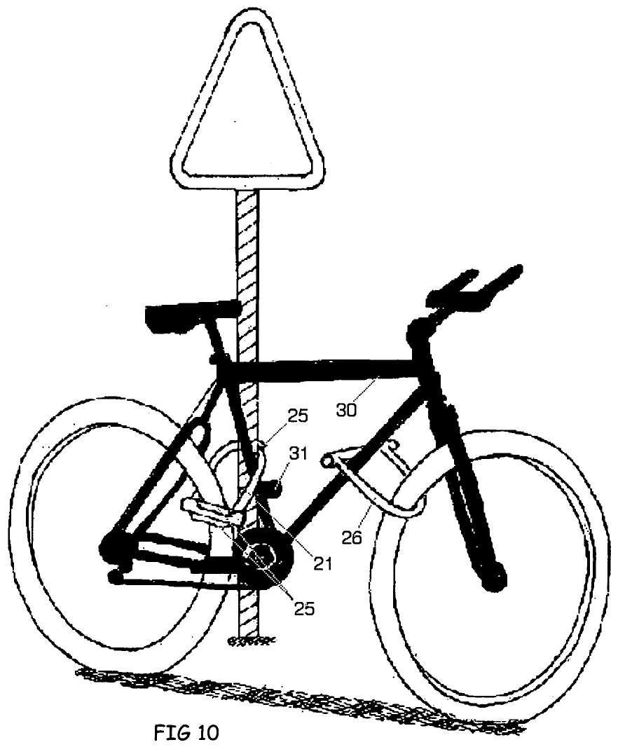

FIG. 10 is a representation of one of the uses of the invention in association with a bicycle. It shows a Tab 25 variation Inner U-Shaped Lock 21, (See FIG. 4A), as well as a conventional Outer U-Shaped Lock 26, (See FIG. 4B). The Inner Lock 21 secures the rear wheel to the Bicycle Frame 30 as well as to a traffic-sign post, while the Outer Lock 26 secures the front wheel to the Bicycle Frame 30. Both wheels are secured to the frame which in turn is secured to a fixed post without the need to remove the front wheel from its' forks. This combination of locks, comprising the components of this invention, is easy to use, convenient to store and provides more security than a single lock or a combination of locks including only one U-Shaped Lock used in conjunction with a (less secure) chain or cable lock. When not in use, both of these locks would fit in the Lock Holder 31, connected to each other as seen in FIGS. 3A and 3B, thus taking no greater space up within the bike frame than just the Outer Lock 26 on it's own.

FIG. 11A is a fragmentary perspective of a bicycle with two U-Shaped Locks, the Inner U-Shaped Lock 21 and the Outer U-Shaped Lock 26, locked together and secured to a bicycle frame using either a conventional bicycle Lock Holder 31 or a lock holder designed specifically for the purpose of connecting two or more locks together. In this figure it becomes evident that the storage of the second lock requires no significantly greater space on the bicycle compared to storing just a single U-Shaped Lock.

FIG. 11B is a fragmentary perspective of a bicycle with the two U-Shaped Locks, the Inner U-Shaped Lock 21 and the Outer U-Shaped Lock 26. The locks are fitted together with the Inner U-Shaped Lock Sleeve 24, (see FIG. 2A or FIG. 5A), such that the locks oppose each other. The locks are secured to the bicycle frame using two conventional bicycle Lock Holders 31, (such as U.S. Pat. No. 6,422,442, (C. McDaid, et al., July 2002), in an alternate embodiment), or a Lock Holder 31 designed specifically to secure a shackle leg. This variation for securing the locks to the bicycle may be more decorative in design, however it may also have the benefit of:

a) Distributing the weight of the locks more evenly on the bicycle, and

b) Securing the locks in two different areas so that they are less likely to move around during bumpy rides, such as when mountain biking on trails.

This embodiment also shows a way in which the locks can be combined in order to extend the distance from which a bicycle can be securely locked to a, hard to reach, secure, fixed and immovable object. This embodiment can also be an example of a way to secure the lock with a Single Rotating Cross Bar, seen in FIG. 8B, on to a bicycle.

FIG. 12A is a fragmentary perspective of an alternate embodiment of the sleeve variation Inner U-Shaped Lock's Cross Bar 23 and Sleeve 24. It reveals a circular Sleeve 24 with segments beyond two opposing parallel transversals removed. It also has Grooves 35 that Tongues 34 on the Outer U-Shaped Lock Cross Bar 28, pictured in 12B, fit securely into.

Note that this variation, and the ones below, all permit the locks to be fitted together with the Inner U-Shaped Lock's Sleeve 24 such that the locks can be locked opposing each other as shown in FIG. 11B. By not requiring this option, other alternate designs, not shown, increase significantly. Furthermore, the Groove 35 and matching Tongues 34 (seen in FIG. 12B) do not need to run the entire length of the cross bar as suggested in these figures. In fact they are not needed at all, even with a circular cross bar, if there is a Clip 49, strap 51, Tab 25 or other related component, added to one or both of the locks, restricting the Inner and Outer shackles from rotating independently (as suggested by the arrows seen in FIG. 8C).

FIG. 12B is a fragmentary perspective of an alternate embodiment of the sleeve variation Outer U-Shaped Lock's Cross Bar 28 designed to fit into the Sleeve 24 seen in FIG. 12A. It reveals a circular Cross Bar 28 with segments beyond two opposing parallel transversals removed. It also has Tongues 34 that fit into the Grooves 35 in the Sleeves 24 shown in 12A.

FIG. 12C is a fragmentary perspective of an alternate embodiment of the sleeve variation Inner U-Shaped Lock Cross Bar 23 and Sleeve 24. It reveals a rounded, rectangular Sleeve 24 that the Outer U-Shaped Lock's Cross Bar 28, pictured in 12D, fits securely into.

FIG. 12D is a fragmentary perspective of an alternate embodiment of the sleeve variation Outer U-Shaped Lock Cross Bar 28. It reveals a rounded rectangle Cross Bar that fits into the sleeve pictured in 12C.

The length of the sleeve(s) can vary for FIGS. 12A and 12B, as well as FIGS. 12C and 12D, as can be seen in FIGS. 2A, 5A and 5B. FIGS. 12A to 12D show two possible variations that help to restrict movement between the Inner and Outer U-Shaped Locks, 23 and 28). They use a Sleeve 24 variation of this invention so that two locks can be conveniently secured together for storage on a bicycle or elsewhere. Many more variations are possible, all of which comprise of components including sleeves, tabs, grooves or even rings—(which can also be described as a tab if not closed or a narrow sleeve if closed, see Ridged Ring 40 which is one possible ring), all of which can secure two or more locks together during storage, which is an advantage of this invention.

FIGS. 12E and 12F show two more alternate shapes for the Outer U-Shaped Locks' Cross Bars 28. These alternate shapes would fit into like-shaped Sleeves 24 that are securely connected beneath the Inner U-Shaped Lock's Cross Bar 23 or on its' side for adjacent locks, as seen in FIG. 17A. Furthermore, similar or alternate shaped sleeves can be placed on an adjacent component that is either part of, or independent of, a Lock Holder 31. Many other shapes are possible for cross bars and accompanying sleeves, some of which may exist in conventional designs.

FIG. 13A is a representation embodying a Vertical Sleeve 41 variation with Outer U-Shaped Lock Cross Bar 28 penetration, showing both locks open. The Inner Lock's U-Shaped Shackle's 22 Legs are penetrating the Outer Lock's Cross Bar 28. Note that in this variation the Inner Lock's Cross Bar 22 is positioned outside of the Outer Lock's Cross Bar 28. In this variation the Outer Lock has the Inner Lock's Shackle 22 Legs go through the Outer U-Shaped Lock's Cross Bar 23, before the Inner Lock's U-Shaped Shackle 22 can be locked to its' Cross Bar 23. Other suggestions for this variation include a Ridged Ring 40, (as seen in FIG. 9C), on the Inner Lock's U-Shaped Shackle 22 legs that would prevent the Inner U-Shaped Shackle's legs from sliding too far into the holes of the Outer Cross Bar 23. It would be useful to have a Bent Foot 39 on the Outer Lock since the holes going through the Outer Lock's Cross Bar 28 could restrict the internal mechanisms required for a lock with two Straight ‘Feet’ 38; and it would be necessary to have two Straight ‘Feet’ 38 on the Inner U-Lock's Shackle 22 Legs since the placement of these legs through the Vertical Sleeves 41 penetrating the Outer Cross Bar 28 would restrict the use of a Bent Foot 39.

FIG. 13B is a representation, in perspective view embodying the Inner U-Shaped Lock's Cross Bar with a Vertical Sleeve 41 variation. Here the Outer Cross Bar 28 would be locked outside of the Inner U-Shaped Lock, unlike FIG. 13A. Like the Grooved End 36 variation as seen in FIG. 9C, this variation would also work effectively with a set of Ridged Rings 40 located on the Outer U-Shaped Lock's U-Shaped Shackles' 27 legs to prevent them from sliding through the vertical sleeve, beyond what is required to lock the Outer Lock 26. The thickness or depth, as well as outer contour of the Vertical Sleeve 41 can vary considerably. This is especially true if the Lock Case and Locking Mechanism 29 are placed under the Cross Bar 23 like they are in the Grooved Ends 36 variation, (see FIG. 9A), because then the vertical sleeve can be shaped in a way that blocks the position of the Lock Case and Locking Mechanism 29 as seen in this figure, (for example, the design could be similar to FIG. 13A but with the Outer U-Shaped Shackle 27, (with two straight feet), penetrating the Inner Cross Bar 23 and the Lock Case and Locking Mechanism 29 for the Inner Cross Bar placed under the Cross Bar between the location of the two Aligned Openings 33). For FIG. 13B, as well as FIG. 17B (below), the outer contour of the Vertical Sleeves 41 can be shaped such that it extends or protrudes, or houses components in order to make securing these locks to a bicycle easier, see the Lock Holder Clip 45 as well in FIG. 17C.

FIG. 13C is a representation embodying a Vertical Sleeve 41 variation. It is of two U-Shaped Locks, the Inner U-Shaped Lock (parts 22 and 23) and the Outer U-Shaped Lock (parts 27 and 28), from their sides, when locked together. These Vertical Sleeves 41 are similar in location to the Grooved Cross Bar Ends 36 shown in FIG. 9A, but the Vertical Sleeves 41 completely encases or surround the Outer U-Shaped Shackle 27. Like FIG. 9A the use of optional Tabs 25 (at the top of the inner shackle's arch), or optional Ridged Rings 40 (on the outer shackle adjacent to the vertical sleeves, see FIG. 9C), may help reduce possible movement when the locks are stored together securely, (these variations are not shown in the figure). Furthermore, with the Inner Lock 21 that is reduced in length, (from cross bar to shackle arc), the locks in this figure can be stored inverted as shown in FIG. 9D.

FIG. 14 is a representation of a locked Inner U-Shaped Lock (parts 22 and 23) and an open/unlocked Outer U-Shaped Lock (parts 27 and 28). It is an embodiment of a Ridged Ring 40 variation of this invention. Ridges on the Outer U-Shaped Lock 26 create raised rings that are recessed inside to make space for Tabs 25 on corresponding parts of the Inner U-Shaped Lock 21, when the two locks are secured together. It is also possible for the positions of the Tabs and Ridged Rings to be reversed.

This embodiment can also be further described as a Tongue 34 and Groove 35 assembly whereby the Ridged Ring 40 is described as a raised Groove 35 and the Tab 25 is described as a protruding Tongue 34. Either way, the ‘male’ and ‘female’ parts serve to secure the two locks, connected together, such that they cannot move independently when stored together. This assembly can be used in conjunction with Sleeves 24, or other components described herein. For example the Tabs 25 and Ridged Rings 40 on the Cross Bars 23 and 28 can be accompanied by a Tab 25 that looks more like the one seen on the outer edge of the Inner U-Shaped Shackle 22 as in FIG. 3A, or on the inner edge of the Outer U-Shaped Shackle 27 as seen in FIG. 5C. Another variation could have circular, (or other shaped), Grooves 35 recessed into the lock's component parts, rather than a Ridged Ring 40 raised outside of the components' surface. FIG. 14 is an excellent example of how components can be added to both locks, rather than just one, in order to secure locks together. An alternate variation could involve longer Tabs 25 on the Inner Cross Bar 23 that penetrate the Outer Cross Bar 28 and lock into position when the Outer Lock 26 is locked. By having the two cross bars, (or other components of each lock), locked together, minimal undesirable movement between the two connected locks could occur.

FIG. 15A is a representation embodying a single Outer Lock 26 and two Inner Locks 21. It uses Sleeves 24 on two Inner U-Shaped Lock Cross Bars 23 that both fit over top of the Outer U-Shaped Lock Cross Bar 28. As mentioned in the Ridged Ring 40 section of ‘Drawings—Detailed Description of Reference Numbers’ above, a Ridged Ring 40 could be placed in the center of the Outer U-Shaped Lock Cross Bar 28 in order to restrict either of the two Inner U-Shaped Lock Cross Bars 23 from impeding upon the other Inner lock, (this variation is not shown in the figure). A Ridged Ring in this location could make the physical act of connecting the locks together easier.

FIG. 15B is a representation embodying a single Outer Lock 26 and three Inner Locks 21. This figure has the Tabs 25 on the Inner U-Shaped Lock Cross Bars 23 fit around or rest on to a leg of the Outer U-Shaped Lock's U-Shaped Shackle 27 (see FIG. 6A), rather than onto the Outer Cross Bar 28, (see FIG. 3A). This variation will work very well with just a single inner and outer lock. It will also work very well with a variety of both Sleeve 24 and Tab 25 variations, and even potentially as a retro-fit with the small inner locks being sold separately to accompany already existing bicycle locks. An advantage to having two or three smaller locks connected together could include securing panniers or locking other smaller components such as a helmet. It could also be handy for commercial/industrial uses where a number of tools or devices may need securing with the benefit of a single key to open all of the locks, as well as the benefit of easy storage for the locks when they are not in use. The inner locks in this figure are shown all aligned facing the same way, when in fact it would be possible for each independent inner lock to slide on to the Outer Shackle legs in either direction. In an alternate embodiment the Outer U-Shaped Shackle 27 could be tapered, getting narrower closer to the arc. This would make the Inner Locks 21 slightly different sizes and could reduce movement between locks when they are connected for storage and transportation.

FIG. 16A is a representation, in perspective view embodying a bent Outer U-Shaped Shackle 27 and the Inner Lock's Cross Bar 23 with a penetrating Sleeve 24. This is the first of several locks shown that are connected together in a side-by-side variation rather than having one lock secured within another. This variation also serves to demonstrate that locks that vary from the traditional U-shape can still be successfully connected together. Note that although the layout differs from other previous examples shown, there is still a Sleeve 24 that serves the purpose of connecting the locks together when the locks are not in use. In this version the Outer U-Shaped Shackle 27 must have Straight ‘Feet’ 38. By reversing which of the Outer Shackle's feet go into the Vertical Sleeves 24, these locks would be inverted, or opposing one another, and so can be used together similarly to FIG. 8B and likewise stored on a bicycle using a Lock Holders 31 such as the one shown in FIG. 11B.

FIG. 16B is a representation, in perspective view embodying the Inner Cross Bar 23 with penetrating Sleeve 24 for bent Outer U-Shaped Shackle 27 legs, similar to the ones on the Outer Shackle 27 seen in FIG. 16A. This version has the Sleeve 24 and the Aligned Openings 32 penetrating the same circular Cross Bar 23, so they are off-set so as not to intersect with one another. The advantage to this version is that the Inner U-Shaped Cross Bar 23 need not be significantly larger than current designs, thus reducing the overall weight of the design in FIG. 16A. This version may work best with a Bent Foot 39 on the Inner U-Shaped Shackle 22 since the Sleeve 24 for the Outer Shackle 27 may impede the locking mechanisms needed for two Straight ‘Feet’ 38.

FIG. 16C is a representation, in perspective view embodying the Inner Cross Bar 23 with penetrating Sleeve 24 for bent Outer U-Shaped Shackle 27 legs, similar to the ones on the Outer Shackle 27 seen in FIG. 16A. This version is designed for the Outer U-Shaped Shackle 27 that has wider legs than the Inner U-Shaped Shackle 22. This could also work equally well, designed with a Inner U-Shaped Shackle 22 that is wider than the Outer U-Shaped Shackle 27, although this alteration would once again suggest the need for a Bent Foot 39 on the Inner U-Shaped Shackle 22, like FIG. 16B, since the Sleeve 24 for the Outer Shackle 27 may impede the locking mechanisms needed for two Straight ‘Feet’ 38. In FIG. 16C the position of the Lock Case and Locking Mechanism 29, (as shown by the location of the Key 37), has been moved since the Sleeve 24 may interfere with positioning the lock at the end of the Cross Bar 23. For each of the Cross Bars 23 shown in FIGS. 16A to 16C there can be an accompanying Inner Shackle 22 or Outer Shackle 27 that is a shape other than the conventional U-shape, (as seen in FIGS. 6A and 6B for example). Furthermore, a single Cross Bar 23 could lock both locks as seen in FIG. 8A.

FIG. 17A is a representation, in perspective view embodying the Outer U-Shaped Lock 26 and the Inner U-Shaped Lock 21 connected together side-by-side using a Sleeve 24 on the Outer Cross Bar 28 that is perpendicular to the positioning of the U-shaped shackles. The Outer U-Shaped Lock has Sleeves 24 on the side of the length of the Cross Bar 28 that securely hold the Inner lock designed to fit into the sleeve. This particular sleeve has a Groove 35 that fits with the Tongue 34 on the Inner Cross Bar 23. This Tongue and Groove prohibits the locks from rotating when the locks are secured together. Another design could look similar to this figure, but with each of the lock's Cross Bars, (23 and 28) having one of the two Sleeves 24 fastened to it.

FIG. 17B is a representation embodying locks secured together, side-by-side, using an independent Sleeve Bar 43. In this variation there is a separate, independent Sleeve Bar 43 with four Vertical Sleeves 41. The Sleeve Bar 43 can either come with, or be sold independently from, one or two U-Shaped locks or other locks. Ridged Rings 40 on the Shackle legs could help to keep the Sleeve Bar 43 in position. By reversing which direction one Outer Shackle's feet go through the Vertical Sleeves 24, these locks would be inverted, or opposing one another, and can be used together similarly to FIG. 8B and likewise stored on a bicycle using Lock Holders 31 such as those shown in FIG. 11B.

There are many options for the design of this version including:

a) The independent Sleeve Bar 43 can house components that make it easier to be mounted onto a bicycle, see FIGS. 17C to 17E.

b) The Sleeve Bar 43 can be connected to one of the Cross Bars (23 or 28 so that it serves as a sleeve for only the other lock. This is a combination between the Cross Bar 23 in FIG. 16A and the Sleeve Bar 43 in FIG. 17B, where the Sleeve Bar extends out of the Cross Bar 23, and so the penetrating Sleeve 24 as seen in FIG. 16A becomes a Vertical Sleeve 41 as seen in FIG. 17B. See FIG. 13B for another variation of this. Also, in these alternate variations the sleeves do not need to be the entire length of the cross bar.

c) The Sleeve Bar 43 can be contoured to reduce its' overall weight, as seen in FIG. 17D. Furthermore, the contours can have numerous design appeals while still serving the purpose of connecting two locks together in a confined space, when not in use.

d) The Sleeve Bar 43 could secure just one of the two arms of each lock with either Ridged Rings 40 or an extension below the sleeve to hold or clamp on to a section of the locks' Cross Bars (23 and 28) in order to prevent the two locks from moving independently when secured together. A version of this that considers both the ridged ring and the extension is described in FIG. 17E below.

e) The Sleeve Bar 43 could be designed to house more than two locks. Although not shown, FIG. 17E is an example of a Sleeve that can easily have three or more Vertical Sleeves 41 side-by-side rather than just the two shown.

f) The Sleeve Bar 43 can secure nested locks. If FIG. 13B was made into a flat, independent bar rather than a Cross Bar 23, then it could hold the Inner Lock 21 nested within the confines of the Outer Lock 26. This alternate design would work well with Ridged Rings 40 used to keep the Sleeve Bar 43 from shifting up the Shackle (22 and/or 27) legs. Like FIG. 17C, a Lock Holder Clip 45 can be mounted on this Sleeve Bar 43.

Side-by-side locks can be useful since these locks can both be equally large. For example, a motorbikes would be a location where the size of the locks may need to be significantly larger compared to designs that have the Inner 21 lock that is somewhat smaller than the accompanying Outer 26 Lock.

FIG. 17C is a representation embodying the Independent Sleeve Bar 43 similar to the one seen in FIG. 17B, with the addition of a Lock Holder Clip 45. This clip fastens to a Lock Holder 31 that is secured on to a bicycle. For more information on the Lock Holder Clip 45, see FIGS. 19A and 19C.

FIG. 17D is a representation embodying the Independent Sleeve Bar 43 that houses a Lock Holder Clip 45, which in turn is attached to a Lock Holder 31. This version of a Sleeve Bar 43 has been contoured to reduce the overall weight of the sleeve. Furthermore, the Vertical Sleeve 41 is open in this version, although the Shackle legs would still have to slide into the sleeve. Other versions that have Tabs as opposed to Sleeves are possible, with a section of the Sleeve Bar clasping or clipping over the shackle leg after it is placed into the tab, or the shackle leg could have Clips 49 such as the ones seen in FIG. 20B.

FIG. 17E is a representation embodying the Independent Sleeve Bar 43 that houses a Lock Holder Clip 45. This version of the Sleeve Bar 43 secures just one of the two shackle legs on each of the locks it secures. A single legs from the two locks each go through two Vertical Sleeves 41. Ridged Rings 40 on legs can prevent the Shackle (22 or 27) Leg from going too far through the top Vertical Sleeves, and an optional extension below the bottom Vertical Sleeves prevents the Cross Bars (23 and/or 28) from shifting when the two locks are secured. A third extension can be placed between where the two Lock Cross Bars would sit, below the bottom Vertical Sleeves 41 so that even when there is just one lock in the sleeve, its' movement is still restricted. This figure also shows a fragmentary representation of a Shackle 22 or 27 leg and Cross Bar 23 or 28 that would fit into one each of the upper and lower Vertical Sleeves 42 as signified by the arrows.

FIG. 18A is a fragmentary representation of the Inner U-Shaped Lock's Shackle 22 and the Outer U-Shaped Lock's Shackle 27, showing their arcs as well as a Tab Extension Arm 44. This extension arm extends the Tab 25 into position, securely butted against the inner arc of the Outer U-Shaped Lock's Shackle 27. In each case below, the Cross Bars 23 and 28 are positioned together with the aid of Tab(s) 25, Sleeve(s) 24, (examples can be seen in FIGS. 3A and 5A respectively, but are not shown here), or other components mentioned previously. Furthermore, there is a gap between the two arcs of the Inner Shackle 22 and the Outer Shackle 27, making the need for an extension arm necessary. There can be many variations of this Tab Extension Arm 44, three of which are shown in FIGS. 18B to 18D as well as described below. Each of the following variations have arms that allow the Tab 25 to be pushed or adjusted so that it remains fixed in position on the Outer U-Shaped Lock's Shackle 27 as the arm is compressed/shortened or expanded/lengthened.

FIG. 18B is a copy of one segment of FIG. 18A, it shows a Tab Extension Arm 44 consisting of a Spring Loaded Collar. The tension of the spring keeps the Tab butted against the Outer Lock when the two locks are secured together.

FIG. 18C is a variation of a segment of FIG. 18A, it shows a Tab Extension Arm 44 consisting of a Threaded Fitting with Free Turning Collar. The Free Turning Collar allows the Tab to remain aligned with the Outer Lock when the size of the extension arm is being adjusted.

FIG. 18D is a variation of a segment of FIG. 18A, it shows a Tab Extension Arm 44 consisting of a Turn Buckle. Similar to the Free Turning Collar, the Turn Buckle allows the Tab to remain aligned with the Outer Lock when the size of the extension arm is being adjusted.

Further variations for a Tab Extension Arm 44 can be seen in FIGS. 20A to 20C, whereby the Tab Extension Arm 44 actually pulls the arcs of the two shackles closer together rather than pushes them apart in order to reduce movement between the two locks when they are secured together.

FIG. 19A is a representation embodying a conventional bicycle Lock Holder 31 as well as an independent Lock Holder Clip 45 that is attached to a fragmentary representation of a U-Shaped Shackle's (22 or 27) leg with a Straight Foot 38. The Lock Holder 31 (or 48) can be secured to the Bicycle Frame 30 as shown in FIG. 11A. The Lock holder has a spring loaded Tongue 34, (that protrudes out of a recess in a Tongue and Groove assembly), which fits securely into a Groove 35 in the Lock Holder Clip's 45 Tongue and Groove assembly when these two components are fitted together, (as seen in FIG. 17D). To release the Lock Holder Clip 45 from the Lock Holder 31 (or 48), there is a Lock Holder Clip Release Button 46 that allows the spring loaded Tongue 34 to recess.

There are many components that the Lock Holder Clip 45 can fasten to so that two locks can be secured in a lock holder of a conventional design such as the one shown in this figure, including:

a) A Shackle (22 or 27) leg or shackle arc
b) A Cross bar (23 or 28)
c) An Independent Sleeve Bar 43
d) A Tab 25 or Sleeve 24
e) A Clip 49, Cord 50 or Strap 51, (these can also be fastened to the Lock Holder 31 (or 48), or Lock Holder Clip 45.
   In each case listed above, a single lock holder can be used to hold two, or more (see FIGS. 15A and 15B), locks that have been secured together so that they cannot move independently when stored together. In the case of fitted locks such as FIG. 1 the two locks are stored in a space no larger than the space required to store just the Outer U-Shaped Lock 26. Also, in the case of side-by-side locks such as FIG. 17A, a single lock holder, or lock holder clip, can be placed conveniently on either of the two locks and the two locks take up the same area within a bicycle frame as a single lock, with only the width of the space required doubling.

FIG. 19B is a representation, in perspective view embodying a conventional bicycle Lock Holder 31 that uses a Pressure Lever 47 to squeeze the components of the lock into position. Like the lock holder seen in FIG. 19A, and as mentioned above, this single lock holder can be used to secure more than one lock. An alternate design can have side-by-side locks secured in the space that a single lock is normally placed, thus the lock holder secures a component or components of both locks, in a single area. Many conventional designs for Lock Holders 31 currently manufactured can be used with this invention with little or no adaptations necessary, however the following lock holders have been adapted specifically for the purpose of storing two locks together conveniently.

FIG. 19C is a representation embodying a Double Lock Holder 48 as well as two independent Lock Holder Clips 45. It is a lock holder design similar to FIG. 19A, described in detail above, with the addition of all the necessary components to hold two Lock Holder Clips 45 rather than just one. A Double Lock Holder 48 is a lock holder that holds two independent locks. This is very convenient since the addition of a second lock holder on to a single component allows the two locks to be stored together without any additional components being added to either of the locks. Therefore, this lock holder allows the user to attach the Lock Holder Clips 45 to locks of different shapes and sizes, and from different manufacturers, and so a Double Lock Holder 48 can be sold without locks, with just one lock, with two independent locks, or with side-by-side or fitted locks allowing the storage of more than just two locks. The lock holder clips can each be attached to one lock which in turn are connected to another lock, for example, each of the Lock Holder Clips 45 could be attached to two different Outer Lock's 26 U-Shaped Shackles 27, (like the one seen in FIG. 4B), such that this Double Lock Holder 48 can hold 4 locks, (with two Inner U-Shaped Locks 21 securely fitted within the said Outer Locks 26, which in turn are secured in the said lock holder). Furthermore, an additional component can be added to secure a third independent lock with a third Lock Holder Clip 45 attached.

FIG. 19D is a representation, in perspective view embodying a Double Lock Holder 48. It is a lock holder design similar to FIG. 19B, described above, with the addition of all the necessary components to hold two locks, rather than just one, independent of each other. Each of the spaces for bicycle locks would have their own Pressure Lever 47, but in the figure only one is seen since the second one would be on the other side of the lock holder. Note the detailed description above for FIG. 19C, which is another variation of the Double Lock Holder 48. Many conventional Lock Holders 31 currently used can be adapted or redesigned to meet the goal of this invention: to gain the advantage of having two or more locks stored conveniently and compactly together when not in use.

FIG. 19E is a representation, in perspective view embodying a Double Lock Holder 48. It is a lock holder design similar to FIG. 19B, described above, with the addition of all the necessary components to hold two locks, rather than just one, independent of each other. This figure is a grayscale rendering of the Double Lock Holder 48 seen in FIG. 19D.

FIG. 19F is a fragmentary perspective of a bicycle with a Double Lock Holder 48 secured to the bicycle frame. The two locks are secured facing the same direction such that one lock would sit directly within the frame of the bicycle while the second lock would sit close to the first lock and parallel to the frame. These locks can be of varied sizes, and can have alternate shapes. In this embodiment of a Double Lock Holder 48, one of the said locks is secured in the same position as the Kryptonite® Side Mount Multi-position Bracket sold in conjunction with Kryptonite Locks including the KRYPTOLOK™.

FIG. 19G is a grayscale rendering of the Double Lock Holder 48 seen in FIG. 19F. This figure shows the location of the Lock Holder Pressure Levers 47 that secures the locks in place. The component that does not have a said lever is where the lock holder is secured to the bicycle frame as seen in FIG. 19F.

FIG. 19H is a fragmentary perspective of a bicycle with a Double Lock Holder 48 secured to the bicycle frame. The two locks are secured facing opposing directions such that one lock would sit directly forward, and (preferably but not necessarily,) within the frame of the bicycle while the second lock would sit behind the first lock, heading to the back of the bicycle. These locks can be of varied sizes, and can have alternate shapes. Like FIG. 19F above, in this embodiment of a Double Lock Holder 48, one of the said locks is secured in the same position as the Kryptonite® Side Mount Multi-position Bracket.

FIG. 19I is a grayscale rendering of the Double Lock Holder 48 seen in FIG. 19H. The lock holder at the bottom of the drawing is the one positioned like the Kryptonite®D Side Mount Multi-position Bracket in relation to the component that secures the lock holder to the bicycle frame.

FIG. 19J considers nine more possible locations for two lock holders to be secured to a bracket. Most, but not all, of the illustrated lock holders are secured to the bracket such that at least one of the two locks are positioned in a side mounted position. This position, useful for mounting two locks on one holder, is similar to the one seen in the Kryptonite® Side Mount Multi-position Bracket. When considering alternate designs certain changes may be made without departing from the intent of securing more than one lock together on a bicycle. These locations are illustrative rather than limiting in scope: They suggest just a few of the possibilities of securing more than one lock to a lock holder bracket.

FIG. 20A is a fragmentary representation of the arcs in the Inner U-Shaped Lock's Shackle 22 and the Outer U-Shaped Lock's Shackle 27 with a Clip 49 and Cord 50 used to connect the two locks. It also shows the lower fragmentary view of the Cross Bars 23 and 28, secured together with a Sleeve 24. This Clip 49 and Cord 50 assembly shows a taut cord that is pinned or riveted to itself around the Inner Shackle 22 and pinned or riveted to a Clip 49 that is secured to the Outer Shackle 27. As well as being pinned or riveted to itself, a Cord 50 could also be glued, bonded, or woven into itself, depending on the materials used for the cord. In FIGS. 20B and 20C, the Cross Bars 23 and 28 could also be positioned together with the aid of a Sleeve(s) 24 (see FIG. 5A), or a single sleeve like FIG. 20A, or other components mentioned previously. In all of these figures, the Cross Bars 23 and 28 could also be secured together with the use of a Clip 49, or clips, as well as by a Strap 51, (see FIG. 20C). Clips 49 can be attached to Straps 51 as well as Cords 50.

There can be many variations of Clips 49 that can be placed in a variety of locations in order to secure two locks together. As seen in the variations shown in these figures, the Clip 49, Cord 50, and Strap 51 can be considered components of a Tab Extension Arms 44, as first seen in FIG. 18A. Furthermore, with both Cord 50 and/or Strap 51 variations a Sleeve 24 could be used rather than a Clip 49. FIG. 9D where the cross bars oppose one another, and FIG. 6D with an alternate shaped lock are examples where clips, cords and straps could also be used in different locations.

FIG. 20B is a variation of a segment of FIG. 20A, it shows a Clip 49 and Cord 50 assembly consisting of a cord and two clips. This figure also has Ridged Rings 40 on the Outer Shackle arc to prevent the top clip from sliding to a section of the outer shackle's arc where the tension between the two locks, created by the cord, is lost or lessened. Another Ridged Rings 40 could be placed on the Inner Shackle 22 to secure the position of the second Clip. A Clip 49 and Cord 50 of this design would also work very well securing the straight parts of the shackle legs, the cross bars, or even to connect to the same shackle leg after the cord is strapped completely around both locks. Clips can be a variety of shapes, and can be very versatile in securing two locks so that they can be conveniently stored together.

FIG. 20C is a variation of a segment of FIG. 20A, it shows a Strap 51 that, in a similar way to the Clip 49 and Cord 50, secures the two locks together. This strap is secured to itself by means of Hooks and Loops, (an example being Velcro®). Like the clip and cord, straps such as these, or ones fastened by buttons, clasps, or snaps, could be used in a variety of ways to fasten two locks so that they can be conveniently stored together. The Strap 51, (as well as Cords 50 above), could be an independent component or they can be attached (or fixed) to one of the components of a lock. Combinations of these components in conjunction with each other, with the locks, and with other components such as Sleeves 24 and Tabs 25 and other components such as Lock Holders (31 and 48) and other independent components are advantageous since they are affordable, durable, and easy to use in conjunction with locks already purchased by consumers.

### DETAILED DESCRIPTION—DIMENSIONS AND MATERIALS

Note: Some Dimensions and Materials have already been included in previous sections, primarily in the ‘Drawings—Detailed Description Of Reference Numerals’ section and throughout the Preferred Embodiments.

There are a variety of prior art locks related to this invention that are currently on the market. These related locks vary significantly in size. Some of the larger bicycle locks on the market include:

The Oxford® Hercules OF144 which is 7.08″×12.59″ (18 cm×32 cm),

The ABUS® Sinus Plus 47 Lock which is 5.9″×11.8″ (15 cm×30 cm),

The ABUS® Granite Extreme Lock which is 7.08″×10.23″ (18 cm×26 cm),

The Kryptonite® Evolution 2000 ATB which is 5″×9″ (12.7 cm×22.9 cm), and

The Kryptonite® Evolution 2000 LS, (and the Kryptolock MC Motorcycle U-Lock), which are both 4″×11.5″ (10.2 cm×29.2 cm).

All of these locks, as well as locks larger than this, (for example motorcycle locks), would make ideal sizes for an Outer U-Shaped Lock 26, or two side-by-side locks. The accompanying Inner U-Shaped Lock 21 would be slightly smaller, but still fully useful to secure the bicycle.

Looking at the smaller end, in an extreme example, a width as small as 4 cm and a length of 12 cm, (measuring between and inside the shackle legs for length, and from inside the cross bar to the inside of the arc of the u-shaped shackle), an Inner U-Shaped Lock 21 would easily fit into any of the locks mentioned and still be able to be locked through the back wheel of most bicycle designs; with one Shackle leg inside and the other Shackle leg outside the two Top Stays and Chain Stays on the rear wheel of a Bicycle Frame 30, thus securing the rear wheel to the frame. With the smaller lock securing the rear wheel to the frame, the larger Outer Lock can secure the front wheel to the main frame of the bicycle as well as to a fixed, secure object that the bicycle is being secured to. Many of the two-lock variations in the Figures can have Inner U-Shaped Locks 21 that are significantly larger than, and even more functional than, the 4 cm×12 cm example size specifications.

As the Outer lock gets smaller in design, the Inner lock must be proportionately smaller too, and so some of the smaller designs such as Kryptonite®'s Evolution 2000 Mini which is 3″×5.5″ (7.6 cm×14 cm) may be too small to serve as an Outer Lock, but would still be fully functional as a side-by-side or Inner Lock. Also, as mentioned when referring to motorcycle locks, larger locks are both possible and functional. Furthermore, with respect to side-by-side locks and locks connected by an additional component such as a Sleeve Bar 43 or Lock Holder 31 and 48, since the locks can be equal in size, their size and shape can vary beyond the specifications mentioned above.

The materials used on current conventional locks on the market can be used in the construction of this invention. U-Shaped Shackles (22 and 27) can be made of, (but are not limited to), heat treated, high-grade, hardened steel. They are usually, but not always, made of solid cylindrical, (or other shaped), rod stock. They are significantly sturdy and thick to provide significant resistance to hack saws, bolt cutters and levers.

Cross Bars (23 and 28) can also be made of, (but are not limited to), heat treated, high-grade, hardened steel. They are usually hollow/tubular so that they can house the Lock Case and Locking Mechanism 29 and the Shackle ‘Feet’ (38 or 38 and 39). Most locks are covered with a protective layer of rubber, plastic or vinyl. This protective layer not only protects the lock, but also the bicycle, as the lock components are placed and locked onto, and removed from, the bicycle during everyday use. Any of these materials used on conventional locks can be used on this invention. However, some components such as Tabs 25 may require special attention or application of the protective layer. For example a rubber sleeve traditionally used on the U-Shaped Shackles (22 and 27) of some conventional locks may not fit easily over a Tab 25 located on that U-Shaped Shackles (22 and 27). Therefore, alternate means of putting the protective layer on such components may be required, such as dipping or spraying the components with the protective layer. Also not shown, but fully functional with this invention are conventional lock covers.

None of the invention's variations shown require a lock or locking mechanism that is constructed differently than those currently used by existing, conventional designs, and many future designs will also function equally as well.

Almost all additional components including, but not limited to, Sleeves 24, Tabs 25, Tongues 34, Grooves 35, ridged Rings 40, Vertical Sleeves 41, Sleeve Bars 43, and Lock Holders 31 can again be made of, (but are not limited to), heat treated, high-grade, hardened steel. The thickness of these components will depend on the component and its' function, but they will be sturdy enough to insure durability. Note that since these components are necessary for securing the locks together when stored and do not compromise the security of the lock, they need not be as thick and strong as the U-Shaped Shackles (22 and 27) and the Cross Bars (23 and 28).

The High Compression Foam 42 as well as the size varying components of the Tab Extension Arm 44 are conventional in construction and/or materials. They are used by this invention for specific purposes described herein.

### DETAILED DESCRIPTION—ALTERNATE EMBODYMENTS

Although many of these embodiments have already been presented, this section expands on the use of this invention in ways that may not have been explicitly covered.

Two, or more connected U-Shaped Locks can be used in conjunction with a motorcycle, trailer, bicycle or utility hitch, motor home, motor scooter, moped, go-cart, motorized bicycle, or other recreational vehicle/valuable possession. Other uses may also be served when camping, or fishing, or on construction/worksites, or anywhere where the use of more than one U-lock is desired along with the efficiency of storing the locks conveniently together.

The locks need not be U-Shaped Locks, but rather they may be of an alternate shape, preferably, but not necessarily, with both locks being rigid and thus more secure than current cable and chain locks. Furthermore, the locks need not be similar in style or design in order to be connected. This invention can also be used to connect a rigid lock to a cable or chain lock, or other less rigid or other shaped lock. See FIGS. 6F and 6G for two of the many possible examples of alternate shaped locks.

Flexible locks can be connected. Components, described in the five primary means for connecting locks, can be used in ways that this patent suggests, to secure a flexible lock within, or adjacent to another lock that is either rigid or flexible.

Connected locks can also be stored within some flexible locks. The STOCKS LOCKS® Original Stocks Lock and SuperStocks Lock, are two flexible U-locks that are examples of flexible, yet still very durable and secure locks that can serve as effective Outer Locks 26, (smaller versions of this lock could serve as Inner Locks 21, or these locks could also be connected adjacent to each other).

A lock can be placed inside of a fixed or anchored lock such as the Oxford® Defiance Ultra Strong Anchor. The Inner U-Shaped Lock 21 stored here can be used to secure the unlocked wheel, or a helmet, while the motorcycle is secured conveniently inside this anchored, pivoting motorcycle lock. This added inner lock could be shaped differently (than a traditional U-lock) in the above mentioned square lock, (or another anchor lock), in order to maximize the space within this lock, (for example see the Inner Lock 21 in FIG. 6A which would fit well in a square lock).

More than two locks may be fitted together or secured side-by-side, (i.e. side-by-side-by-side), or side-by-side locks may also have locks fitted within them. See FIGS. 15A and 15B for other multiple connected locks.

The lock(s) can house components that assist them in being secured on to a bicycle or other location. See Lock Holder Clip 45 in FIG. 19A.

A single lock may be sold with components of this invention so that it can be stored or connected with other currently existing locks, or a group of locks with varying specification.

Components of this invention can be used to secure one or more locks into a confined area, or segment of a bicycle frame, without the aid of an independent lock holder.

Locks can serve to secure panniers, (and potentially lock them shut), to a bicycle so that these panniers may be left secured to the bicycle. Other components such as helmets or backpacks or other gear may be secured to a bicycle using one or more of the locks. Although many of these items may not currently have components, holes or sections of them that are favorable to being locked with a U-lock, this may be a result of U-locks not traditionally having enough space to secure these items. With a second lock stored on a bicycle, many items could be redesigned significantly, or just slightly, to accommodate the use of a second lock on a bicycle to secure such items.

Alternate Embodiments Incorporating Prior Art—More ideas for securing this invention to a bicycle include:

a) Adapting U.S. Pat. No. 5,647,520, (C. McDaid, July 1997) where the spline(s) described may be placed on either the outside of the sleeve of the invention's inner lock 24 (Possible on a variation such as FIG. 1) or the bottom of the cross bar of the invention's outer lock 28 (Possible on a variation such as FIG. 3) depending on which design of this invention is being considered. (This is unlike the patent that describes the spline(s) as fixed to one of the legs of the U-Shaped Shackle (22 and 27)). This positioning of the spline(s) would allow the bulk of the weight of this invention, (having two locks that need supporting rather than just one), to be held securely, near the frame of the bicycle.

b) One similar design to McDaid's spline patent, called the “Lickity Click” and seen on Bike Guard® locks, has a Tongue 34 assembly attached to the Bicycle Frame 30 and a matching Groove 35 assembly on a Lock Holder Clip 45 secured to one of the legs of the U-Shaped Shackle (22 and 27), (See FIG. 19A for this conventional design, or FIG. 19C for one adapted by this invention). This holder would be fully functional with this patent if placed on one of the legs of the Outer U-Shaped Shackle 27, or elsewhere on one of the other components;

c) U.S. Pat. No. 6,422,442, (C. McDaid, et al., July 2002) with a flexible brace and collar can be used whereby two of these lock holders, or lock holders that serve a similar function, would be used as drawn in FIG. 11B.

### CONCLUSION, RAMIFICATIONS, AND SCOPE

In many instances, where the use of a portable (primarily U-shaped) lock is convenient, there proves to be both benefit and convenience to having a second portable (primarily U-shaped) lock. Furthermore, the ability to store these locks in a limited space, not significantly greater than securing a single lock is desirable.

In the case of securing a bicycle, a U-Shaped Lock is often used to lock the rear wheel to the frame of the bicycle and to a post, or pole, or other object that is fixed and secure. Often at least one of several challenges are faced, including:

1. Removing the quick-release front wheel and locking it in the U-Shaped Lock with the items mentioned above. This involves removing and replacing the front brake wire.

2. A front wheel that is bolted, and not quick-release, can easily be stolen if further measures are not taken to protect it.

3. Finding other means to lock the front wheel, such as making space on the bicycle, or in a pack, in order to carry a chain or cable style lock or a second U-Shaped Lock.

4. The pole/post/park bench or other object that the bicycle will be secured to is too large and cannot fit within the U-Shaped Lock when all other parts of the bicycle, such as the front wheel, are also placed within the U-Shaped Lock.

5. When using just one U-Shaped Lock, it is often necessary to place the lock close to the ground where it is easier for thieves to get leverage, which can aid in the theft of a bicycle.

6. Other items that would be convenient to secure cannot fit in the U-Shaped Lock when all other said parts of the bicycle, motorcycle or other valuable possession are also placed within the U-Shaped Lock.

7. Many bicycle racks, used to transport bicycles outside of a vehicle, require additional lock(s) to secure the bicycle, and/or components of a bicycle, to help prevent against theft.

8. Parents of younger children will often ride to a park or to a child's sporting event location and their younger children may not have a lock or room for a lock on their bicycle.

The advantages of this invention, having two U-shaped locks fastened together as one unit when stored, alleviates the challenges and inconveniences mentioned above:

1. With a second U-Shaped Lock, the front wheel can remain on the bicycle and be locked to the frame, and/or the secure object, separately from the lock used at the rear wheel, (which could be locked to a different part of the secure object for added security).

2. A bolted front wheel, that is not quick release, can be locked for added security, in addition to the rear wheel and frame.

3. No more storage is necessary for a second lock than the space already needed for the first lock. Also a second U-Shaped Lock provides greater security than a chain or cable lock.

4. The second lock can be used to secure the bicycle to the pole/post/park bench or other object, especially when the first lock is not adequately large enough to do so as well as secure everything else mentioned previously. For example, a 2′×4′ plank on a park bench would not fit in most U-Shaped Locks along with the rear wheel and bicycle frame, much less other bicycle components. One of the two U-Shaped Locks can be used solely to lock the frame of the bicycle to larger secure objects.

5. A second lock acts as a greater deterrent to thieves who would rather prey on an easier target with just a single lock to overcome. Also, this second lock can be placed in a position that either locks the bicycle frame to the secure object a second time, (in addition to the first lock), or locks the bicycle frame to a second secure object. Also, with the first lock already securing the bicycle, the second lock can lock the bicycle frame, a second time, in a position that restricts a thiefs access to the second lock.

6. Items such as another bicycle, or a motorcycle helmet, can be secured despite the fact that the other lock is in use and has no room to fit such items.

7. Storing 2 locks together provides the versatility of carrying and storing two locks in the space provided for just one lock, (even when the locks are not stored on the bicycle). So, both locks can be made available, to secure a bicycle to a rack on a vehicle, when the locks are kept, conveniently together, on a bicycle, in the vehicle or anywhere else in the possession of the user. Also, the second lock can secure the front wheel of one bicycle to the rear wheel and frame of another bicycle when both bicycles are placed on a bicycle rack in opposing directions.

8. Parents can have the convenience of two locks on their bicycle so that they can secure their bicycle as well as their children's.

Many web sites that relate to bicycle security, which provide security tips for locking and securing bicycles, make two notable points:

U-shaped locks provide greater security than chain or cable locks.

Always secure additional bicycle components/accessories.

(Specifically taken from: http://www.nationalbikereg istrv.com/proplock.html)

This invention gives the user the security of a second bicycle lock for locking components, such as the front wheel, and the advantage of storing the second lock conveniently next to, or within, the confines of the first lock.

The advantages listed above demonstrate the usefulness of this invention as it pertains to bicycles and U-locks. As suggested in #6 above, there are advantages as well for motorcycle users, (to lock their helmets for example). This list of advantages could easily be expanded when factoring in other items being secured besides just bicycles and cycling related equipment. Furthermore, one or more of the locks secured or connected to one another may not necessarily be of a current conventional design, without diminishing the usefulness of this invention.

Although conventional locks and more specifically U-Shaped Locks are plentiful, none possess the convenience, or added security of providing a second U-Shaped Lock, (or other shaped lock), fastened to, and stored in conjunction with, the original U-Shaped Lock, (or other shaped lock). Furthermore, this invention is useful because:

It can be sold in conjunction with a conventional lock design.

It can be sold to retrofit the after market purchase of a conventional lock design.

It can combine locks that are completely different in design.

It can store additional, independent locks within the confines of a single lock.

It provides additional security and deterrent to theft compared to single lock designs and multi-lock combinations currently on the market.

It provides additional convenience compared to single lock designs and multi-lock combinations currently on the market.

It provides more volume than what can be stored in any other U-lock, or similar sized lock, without taking up significantly more area on a bicycle.

There are five primary means for connecting together bicycle locks for convenient storage that are covered by this patent:

1. The use of Sleeves 24

2. The use of Tabs 25

3. The combination of varied embodiments of primary means 1 and 2 above.

4. The use of primary means 1, 2, and/or 3 to secure locks side-by-side.

5. The use of a component(s) independent of the locks.

Locks stored together on a bicycle may be:

Connected with one lock stored within the confines of a second lock, when these locks are not being used to secure the item(s) they were purchased to secure; and/or

Stored connected by means of an additional component and/or lock holder; and/or

Stored side-by-side, either attached to each other, and/or mutually attached to an additional component, or lock holder.

The scope of the invention should be determined by the appended claims and their legal equivalents, rather than by the examples given.

I claim:

1. A locking device comprising a plurality of U-shaped locks containing:
one or more inner U-shaped lock with the said inner U-shaped lock comprising an inner cross bar and an inner U-shaped shackle;
one or more outer U-shaped lock with the said outer U-shaped lock comprising an outer cross bar and an outer U-shaped shackle;
an additional appendage moiety to hold two or more locks together;
a lock case-cum-locking mechanism in the form of a disc style cylinder; and
a specific appendage assembly.

2. The locking device of claim 1, wherein the said inner cross bar and/or outer cross bar is configured to contain a set of inner/outer aligned openings and a lock case-locking mechanism.

3. The locking device of claim 1, wherein the said inner cross bar and/or the said outer cross bar is designed in the shape of a square, rounded or oval cylinder.

4. The locking device of claim 1, wherein, the said inner and/or outer cross bar has grooved ends.

5. The locking device of claim 1, wherein the said inner and/or outer U-shaped shackle respectively comprises:
a set of two parallel inner/outer rigid bars (legs) of equal length;
an inner/outer curvilinear bar; and
a set of inner/outer feet.

6. The locking device of claim 5, wherein the said legs are connected to each other by the said curvilinear bar.

7. The locking device of claim 5, wherein the said legs are designed in the shape of a cylinder, rounded cylinder or oval cylinder.

8. The locking device of claim 5, wherein the said inner/outer curvilinear bar of the said inner/outer U-shaped shackle is characterized to connect the said inner/outer legs of the said inner/outer U-shaped shackle respectively.

9. The locking device of claim 5, wherein the said inner U-shaped shackle is in the shape of a magnet.

10. The locking device of claim 5, wherein the said set of inner/outer feet have grooves.

11. The locking device of claim 5, wherein, in the said set of inner/outer feet, one set is straight while the other set is grooved.

12. The locking device of claim 5, wherein the said set of inner/outer feet are characterized by their function to fasten together the said inner/outer U-shaped shackle and the said inner/outer cross bar of the said inner/outer U-shaped lock, with the said fastening function being supplemented by the said inner/outer aligned openings located on the said inner/outer cross bar of the said inner/outer U-shaped lock respectively.

13. The locking device of claim 1, wherein the said additional appendage moiety comprises a sleeve unit and/or a tab unit.

14. The locking device of claim 13, wherein the said sleeve unit consists of sleeve(s) with the said sleeve(s) being tubes or rings which are durable and well joined extensions used for enclosing or encasing a component of one or more other lock(s) in order to connect the locks together, when the said locks are not in use.

15. The locking device of claim 14, wherein the said sleeve(s) is in the form of a vertical sleeve or a sleeve bar, such that the said sleeve(s) completely surround or encircle the components of the said other lock.

16. The locking device of claim 14, wherein the said sleeve(s) is in the form of a vertical sleeve or a sleeve bar or any other shape variation, such that the said sleeve(s) completely surround or encircle the components of the said other lock.

17. The locking device of claim 14, wherein the said sleeve(s) is circular in shape and orientation.

18. The locking device of claim 14, wherein the said sleeve(s) is configured to receive the said outer cross bar of the said outer U-shaped lock.

19. The locking device of claim 18, wherein the said outer cross bar of the said outer U-shaped lock is circular in shape.

20. The locking device of claim 17, wherein the said circular shaped sleeve has segments beyond two opposing parallel transversals removed.

21. The locking device of claim 14, wherein the said sleeve is a rounded rectangular structure.

22. The locking device of claim 21, wherein the said sleeve is configured to receive the said outer cross bar of the said outer U-shaped lock.

23. The locking device of claim 22, wherein the said outer cross bar of the said outer U-shaped lock is in the form of a rounded rectangular structure.

24. The locking device of claim 21, wherein the said rectangular structure of the said sleeve has segments beyond two opposing transversals removed.

25. The locking device of claim 15, wherein the said vertical sleeve is configured to facilitate penetration of the said outer cross bar of the said outer U-shaped lock.

26. The locking device of claim 15, wherein the said vertical sleeve is of variable thickness or depth.

27. The locking device of claim 15, wherein the said vertical sleeve is of variable contour.

28. The locking device of claim 15, wherein the said vertical sleeve completely encases or surrounds the said outer U-shaped shackle of the said outer U-shaped lock.

29. The locking device of claim 13, wherein the said tab unit(s) further comprise:
a groove(s);
a ridge(s);
a tongue (s); and/or,
a tab extension arm.

30. The locking device of claim 29, wherein the said groove(s), the said ridge(s), and/or, the said tongue, are small flaps and/or strips that are durable, well joined extensions which partially embrace the component(s) of another lock, without enclosing completely around them.

31. The locking device of claim 29, wherein the said tab extension arm is an appendage whose primary purpose is to maintain a tight fit between the said tab unit(s) associated with the said inner U-shaped shackle of the said inner U-shaped lock, and the outer U-shaped shackle of the said outer U-shaped lock, when the said locks are secured together.

32. The locking device of claim 31, wherein the said tab unit remains butted against the said outer U-shaped lock when the said U-shaped locks of the said locking device are secured together.

33. The locking device of claim 31, wherein the said tab extension arm consists of a spring loaded collar.

34. The locking device of claim 32, wherein the functioning of the said tab extension arm is dependant on the tension generated by the said spring loaded collar.

35. The locking device of claim 31, wherein the said tab extension arm consists of a threaded fitting.

36. The locking device of claim 35, wherein the said threaded fitting is equipped with a free turning collar.

37. The locking device of claim 36, wherein the said free turning collar allows the said tab unit to maintain alignment with the said outer U-shaped lock in event of the size of the said tab extension arm being adjusted.

38. The locking device of claim 31, wherein the said tab extension arm consists of a turn buckle.

39. The locking device of claim 38, wherein the said turn buckle allows the said tab unit to maintain alignment with the said outer U-shaped lock when the size of the said tab extension arm is being adjusted.

40. The locking device of claim 1, wherein the said specific appendage assembly further comprises:
a ridged ring;
a grooved end(s);
and/or;
a tongue-cum-groove assembly.

41. The locking device of claim 40, wherein the said ridged ring is in the form of a small ridge, a bump or a protuberance, whose main function is to prevent movement between the said inner U-shaped lock and the said outer U-shaped lock of the said locking device, when the said locks of the said locking device are secured together.

42. The locking device of claim 40, wherein the said ridged ring exists in form of ridges on the said inner and/or outer U-shaped lock being characterized to create raised rings that recessed inside to make space for the said tab units.

43. The locking device of claim 40, wherein the said grooved end(s) function to ensure that when the said U-shaped locks of the said locking device are fastened together, they may not move independently of one another.

44. The locking device of claim 40, wherein the said grooved ends are located on the said inner cross bar.

45. The locking device of claim 40, wherein the said grooved ends are used in conjunction with the said outer legs of the said outer U-shaped shackle of the said outer U-shaped lock.

46. The locking device of claim 40, wherein the said grooved ends are configured to work in conjunction with the said ridged ring.

47. The locking device of claim 40, wherein the said grooved ends are located on the said inner cross bar, with the said inner cross bar being inverted.

48. The locking device of claim 40, wherein the said tongue cum groove assembly, further comprises a tongue component and a groove component.

49. The locking device of claim 48, wherein the said tongue component is in the nature of a joint that has a protruding strip and a matching groove.

50. The locking device of claim 48, wherein the said groove component is in the nature of a hollow or indented joint that has a matching protruding strip that fits into the said matching groove of the said tongue component such that the two locks cannot move independently when stored together.

51. The locking device of claim 1, further comprising a mounting means.

52. The locking device of claim 51, wherein the said mounting means is affixed on a securable element by means of a securing element.

53. The locking device of claim 52, wherein the said securable element could be a bicycle or any other like element.

54. The locking device of claim 53, wherein the said securing element is a lock holder.

55. The locking device of claim 51, wherein the said mounting means is in the form of a lock holder or a double lock holder and is provided with a lock holder clip and a lock holder pressure lever.

56. The locking device of claim 55, wherein the said lock holder/double lock holder, is configured to contain a lock holder clip release button.

57. The locking device of claim 55, wherein the said lock holder clip is an independent component securely attached to a part of the said U-shaped lock(s) of the said locking device(s).

58. The locking device of claim 55, wherein the said lock holder pressure lever is a quick release lever used to squeeze and tighten the excess space around the said U-shaped lock of the said locking device.

59. The locking device of claim 55, wherein the said double lock holder is a specific kind of lock holder used for the purpose of connecting or securing more than one lock on a bicycle.

60. The locking device of claim 59, wherein the said double lock holder is provided with a plurality of independent lock holder clips.

61. The locking device of claim 60, wherein, the said independent lock holder clips allow the attachment of more than one locks to the said lock holder.

62. The locking device of claim 59, wherein the said double lock holder is provided with a set of independent pressure levers.

63. The locking device of claim 1, further comprising a friction-reducing element.

64. The locking device of claim 63, wherein the said friction-reducing element is in the form of a high compression foam padding to provide a cushion between the said U-shaped locks of the said locking device.

65. The locking device of claim 63, wherein the said friction-reducing element is in the form of a compressible material to provide a cushion between the said U-shaped locks of the said locking device.

66. The locking device of claim 63, wherein the said friction-reducing element is in the form of a high compression foam padding to provide a cushion between the said components that secure the two or more locks together when said locks are not in use.

67. The locking device of claim 63, wherein the said friction-reducing element is in the form of a compressible material to provide a cushion between the said components that secure the two or more locks together when said locks are not in use.

68. The locking device of claim 1, further comprising a connective element for connecting any components of the two independent locks.

69. The locking device of claim 68, wherein the said connective element further comprises:
a clip(s);
a cord(s);
and/or;
a strap(s).

70. The locking device of claim 69, wherein the said clip(s) is in the form of a fastener.

71. The locking device of claim 69, wherein the said clip(s) partially surrounds and holds a component of the said U-shaped lock and/or the said lock holder.

72. The locking device of claim 69, wherein the said cord(s) is in the form of a flexible connection used to attach any two components when the said locks are not in use.

73. The claim of claim 69, wherein the said strap(s) is in the form of a flexible material used for binding components of said locks together when the said locks are not in use.

74. The locking device of claim 1, wherein the said plurality comprise of a combination in which there exist two inner U-shaped locks and a single outer U-shaped lock.

75. The locking device of claim 1, wherein the said plurality further comprises a combination in which there exist three or more inner U-shaped locks and a single outer U-shaped lock.

76. The locking device of claim 1, wherein the said plurality comprises a combination of alternate shaped locks.

77. The locking device of claim 76, wherein the said combination of alternate shaped locks includes, an outer U-shaped lock and an inner nested lock.

78. The locking device of claim 76, wherein the said combination of alternate shaped locks includes an outer U-shaped lock and an inner magnet shaped lock.

79. The locking device of claim 76, wherein the said combination of alternate shaped locks includes an outer U-shaped lock and an inner frame lock.

80. The locking device of claim 76, wherein the said combination of alternate shaped locks includes an inner U-shaped lock and an outer jaw style lock.

81. The locking device of claim 76, wherein the said combination of alternate shaped locks includes an inner jaw style lock and an outer U-shaped lock.

82. The locking device of claim 76, wherein the said combination of alternate shaped locks includes an inner jaw style lock in conjunction with an outer jaw style lock.

83. The locking device of claim 76, wherein the said combination of alternate shaped locks includes an inner frame lock and an outer jaw style lock.

84. The locking device of claim 1, wherein the said plurality of locks consists of an outer U-shaped lock and an inner U-shaped lock possessing a common connecting component.

85. The locking device of claim 84, wherein the said common connecting component is a tandem sleeve.

86. The locking device of claim 84, wherein the said common connecting component serves to bring the said locks in side by side position, pursuant to being connected.

87. The common connecting component of claim 84, wherein the said connecting component consists of a mounting means.

88. The common connecting component of claim 84, wherein the said connecting component is removable from an attached mounting means.

89. The locking device of claim 1, wherein the said plurality of locks consists of an outer U-shaped lock and an inner U-shaped lock with a common securing means.

90. The locking device of claim 89, wherein the said common securing means consists of an independent sleeve bar being used in conjunction with two or more independent sleeves.

91. The independent sleeve bar of claim 90, wherein the independent sleeves are elevated to secure a component(s) of the said locks.

92. The common securing means of claim 90, wherein grooves, ridges, and/or tabs are used in conjunction with the independent sleeve bar to secure the two said locks.

93. The sleeves of claim 90, wherein components of the said locks are only partially embraced by the said sleeves.

94. The locking device of claim 13, wherein the said sleeve unit exists in the form of an independent sleeve variation.
